(19) United States
(12) Patent Application Publication
(10) Pub. No.: US 2007/0175120 A1
(43) Pub. Date: Aug. 2, 2007

(54) Insulating glass panel and method for producing the same

(76) Inventor: Karl Lenhardt, Bad Liebenzell (DE)

Correspondence Address: Orum and Roth, 53 W Jackson Boulevard, Suite 1616, Chicago, IL, 60604, US

(21) Appl. No.: 10/588,665

(22) PCT Filed: Feb. 3, 2005
(86) PCT No.: PCT/EP05/01048

§ 371 Date: Nov. 13, 2006

(30) Foreign Application Priority Data
Feb. 3, 2004 (DE) 10 2004 005 356.1
Apr. 26, 2004 (DE) 10 2004 020 883.2
Jun. 3, 2004 (DE) 10 2004 027 527.0

(51) Int. Cl. E06B 3/00; E06B 3/964

(52) U.S. Cl. 52/204.62; 428/34

(57) ABSTRACT

The invention relates to an insulating glass pane, in which two separate glass panes (2, 3) are held at a distance from one another by a spacer (4), which consists of a strip and which has an inner side (12), and outer side (6) and two flanks (11). A drying agent is provided in conjunction with the spacer (4), and a gap is provided on both sides of the spacer (4) between the spacer and both glass panes (2, 3). This gap is sealed by a primary sealing compound (19) that adheres to the spacer (4) and to the glass panes (2, 3). The invention provides that a compound (18), which contains a drying agent, is applied to the primary sealing compound (19) that seals both gaps and, afterwards, to the side (12) of the spacer (4) (also referred to as inner side (12) hereafter), this side facing the inner space (17) of the insulating glass pane. Compound (18) is applied so that it covers the inner side (12), that is, as long as the inner side is not already covered by the primary sealing compound (19).

The present invention relates to an insulating glass panel having the features defined in the preamble of claim 1. An insulating glass panel of that kind has been known, for example, from U.S. Pat. No. 5,439,716 A. In the known insulating glass panel, two separate glass panes are kept at a distance one from the other by a thin-walled hollow-section metal bar that comprises an inner side, an outer side and two flanks. The cavity formed in the spacer contains a granular drying agent which is packed sufficiently tight, at least at the corners of the spacer, for being capable of transmitting pressure from one flank to the other flank. The drying agent has the function to absorb and bind any humidity present in the interior of the insulating glass panel so that the temperature in the interior of the insulating glass panel will not drop below the dew point if the panel should cool down. The inside of the spacer is perforated for that purpose so that humidity can migrate from the inner space of the insulating glass panel into the cavity of the spacer for being absorbed. In order to prevent humidity from penetrating into the inner space of the insulating glass panel from the outside, a gap is provided between the flanks of the spacer and the two glass panes, which gap is sealed by a primary sealing compound that adheres to the spacer and to the glass panes. The material predominantly used as sealing compound is a polyisobutylene (butyl caoutchouc) by which an adequate sealing effect to prevent diffusion of water vapor can be achieved. Polyisobutylenes are thermoplastic bonding substances. In addition to their function to seal the interior space of the insulating glass panel, it is a further function of such compounds to establish a temporary bond, during assembly of an insulating glass panel, between the spacer and the two glass panes whose edges are bonded to the spacer. However, due to the thermoplastic nature of polyisobutylenes, the latter are not suited for establishing a durable solid physical connection between the glass panes of the insulating glass panel. In the known insulating glass panels, such bond is instead provided by a curable secondary sealing compound, which is applied between the glass panes to either cover the whole outside of the spacer, extending without interruption from the one glass pane to the other glass pane, or else two ropes are formed from the secondary sealing compound, one of which connects the glass pane with the spacer while the other one connects the second glass pane with the spacer, in which case the outside of the spacer may remain free in full or in part. Usual as secondary sealing compounds are two-component plastic materials, especially polysulfides, polyurethanes and silicon.

Known frame-like spacers formed from hollow-section bars consist, for example, of straight section bars that are filled with a drying agent and are joined to form a frame using corner connection pieces that are fitted in the ends of the section bar. Further, it has been known to form frame-like spacers from a single hollow-section bar in which corners are formed by bending and which are filled with a drying agent either before or following the bending operation, whereafter they are closed using a straight connection piece fitted in the opposite ends of the hollow-section bars. Using a coating machine of the kind known from DE 28 03 132 C2, for example, the frame-like spacer is coated on its two flanks with the primary sealing compound and is applied to a first glass pane so as to adhere to it, whereafter a second glass pane is applied, and is likewise attached, so that a semi-finished insulating glass panel is obtained. The latter is then compressed to its predetermined thickness. Thereafter, a secondary sealing compound is extruded onto the joints on the outside of the spacer, which after curing produces a permanently secure physical bond of the insulating glass panel.

For producing such an insulating glass panel a variety of operating steps are required which in turn require the use of complex machinery, for example a machine for bending metallic hollow-sections, a machine for filling hollow sections or spacer frames with a pourable drying agent, a machine for coating the flanks of the pre-bent spacer with a primary sealing compound, a machine for applying the spacer to a glass pane, a machine for assembling and compressing the insulating glass panel and a machine for filling the marginal joint of the insulating glass panel with the secondary sealing compound, for which purpose a nozzle must be moved around the edge of the insulating glass panel. A device suited for that purpose has been described by DE 28 16 437 C2.

U.S. Pat. No. 6,470,561 B1 discloses an insulating glass panel known under the trade name “Intercept” whose frame-like spacer is formed from a thin-walled metal U-section the open side of which faces the inner space of the insulating glass panel. An intercalation compound consisting of a sticky, gas-permeable matrix material, for example a polyurethane, in which a powdery or granular drying agent is embedded, is extruded into the U-shaped section. For producing the spacer, the flanks of the U section of the section bar are first pre-shaped in the areas where the corners of the spacer are to be formed later, whereafter a primary sealing compound is applied to the flanks. The U-section bar, having been prepared in this way, is then folded by hand to form a closed frame during which operation the flanks move inwardly in the pre-stamped areas. The beginning and the end of the section bar abut at one corner and are joined by welding, for example. The spacer frame, which is limited in size by the instability of the U section, is then placed on a glass pane and pressed onto the latter, whereafter a second glass plane is applied, which likewise is bonded to the assembly. The marginal joint of the insulating glass panel existing on the outside of the spacer is then filled by extruding a secondary sealing compound into the joint, whereby the durable mechanical bond of the insulating glass panel is produced.

While the production of such an insulating glass panel is somewhat less complex than the production of the insulating glass panel described before, it is limited to spacers of small formats and additionally requires three different extrusion steps for attaching the spacer and joining and compressing the insulating glass panel, namely the steps of extruding the matrix containing the drying agent, extruding the primary sealing compound and extruding the secondary sealing compound into the marginal joint of the assembled insulating glass panel. These steps require especially great attention and care to ensure that the beginning and the end of the sealing compound ropes, especially of the primary sealing compound, will be joined without any interruptions.

Instead of using a hollow section or a U section for forming a spacer, it has been further known to extrude a rope of a primary sealing compound with an embedded drying agent onto the first glass pane along its edge, and to thereby form a frame-like structure on the glass pane, to place a second glass pane on the rope, to compress the semi-finished insulating glass panel to its predetermined thickness and to then fill the marginal edge on the outside of the thermoplastic rope with a curable secondary sealing compound. Insulating glass panels of that kind, which are known under the trade mark TPS®, have the advantage that they can be produced in any desired shape. Compared with insulating glass panels provided with a spacer formed from a section bar, they are, however, limited with respect to the spacing between the two glass panes and require the use of considerable quantities of expensive primary and secondary sealing compounds. In addition, care must be taken to ensure that the primary sealing compound and the secondary sealing compound are compatible one with the other so that no undesirable interaction will occur between the primary sealing compound and the cured secondary sealing compound.

The drying agents used usually are molecular sieves (zeolithe).

Further, there have been known insulating glass panels where the spacer is formed by a compound rope consisting of a primary sealing compound, which contains a drying agent and a corrugated steel band intended to impart to the spacer stability and compressive strength. That rope, known as swiggle strip, is pre-fabricated and is then drawn off the roll for application. Supply rolls must be stored in a humidity-tight way so that the drying agent will not be saturated prematurely with water vapor. It has been known (EP 0152807 B1) to apply such a swiggle strip on a glass pane using a machine, which operation requires that the glass pane be moved linearly and be rotated. This is a complex process. In addition, it is difficult with such insulating glass panels to make the joint between the beginning and the end of the swiggle strip water-tight. The outside of the spacer formed by a swiggle strip is left with a marginal joint in the insulating glass panel, which is then sealed using a curable secondary sealing compound. Because of the existing serious disadvantages, insulating glass panels using a swiggle strip and a spacer have not made their way in the marketplace.

Now, it is the object of the present invention to show a way of designing and producing insulating glass panels at lesser cost, without having to cut back on the quality of the seal and on the mechanical stability of the insulating glass panel. At the same time, the invention is to be suited for producing large quantities of standardized insulating glass panels.

This object is achieved by an insulating glass panel having the features defined in claim 1. Claims 34 and 36 provide a method which is especially well suited for producing such an insulating glass panel. Advantageous further developments of the invention are the subject-matter of the sub-claims.

A glass panel according to the invention comprises two separate glass panes, which are kept at a distance by a spacer formed from a section bar and which are bonded to the latter by a primary sealing compound. The primary sealing compound bonds the two flanks of the spacer tightly to the two glass panes and seals the inner space of the insulating glass panel against penetrating water vapor and—in the case of insulating glass panels filled with a heavy gas—against losses of heavy gas. The primary sealing compound, which performs its sealing action in the two gaps between the glass panes and the spacer, is followed directly and closely by a compound containing a drying agent, especially molecular sieves, which on the one hand absorbs and binds any humidity present in the inner space of the insulating glass panel, and on the other hand intercepts and binds any water vapor that may diffuse into the compound from the outside. That compound covers the side of the spacer that faces the inner space of the insulating glass panel, to the extent that side is not already covered by a primary sealing compound. If necessary, the primary sealing compound is followed on its outside by a curable secondary sealing compound, which preferably is applied immediately adjacent the primary sealing compound, which connects the two glass panes one with the other, directly or indirectly, and which provides a durable mechanical and firm connection between the glass panes. In the case of a direct connection, the secondary sealing compound extends from the one glass pane over the outside of the spacer up to the other glass pane. An indirect connection can be produced by the use of two separate ropes of the secondary sealing compound, with the one rope connecting the one glass pane and the other rope connecting the other glass pane with the spacer. If the selected primary sealing compound is capable of simultaneously guaranteeing the durability of the mechanical connection of the glass panes required for an insulating glass panel, then no secondary sealing compound is needed. A sealing compound of the kind that meets the demands placed on both a primary and on a secondary sealing compound can be obtained, for example, by a mixture of a thermoplastic component (having a good sealing effect against water vapor diffusion) with a permanently curing component (providing a firm mechanical bond).

The invention provides considerable advantages:
The primary sealing compound between the glass panes and the flanks of the spacer, in combination with a compound that contains a drying agent, forms on the inside of the spacer an uninterrupted barrier that encloses the inner space of the insulating glass panel from one glass pane to the other glass pane. This barrier is in addition to the barrier that is formed by the spacer as such.
The compound containing a drying agent, preferably is a sealing compound identical or identical in effect to the primary sealing compound and not only hinders diffusion of water vapor but acts to bind any water vapor that may diffuse into the compound, with the dual effect that the dew point in the inner space of the insulating glass panel is lowered and the sealing effect against ambient air is improved. Thus, the compound unites in itself the functions of a seal and of an absorber.
Compared with a TPS® insulating glass panel, diffusion of water vapor into the insulating glass panel is hindered because the cross-section over which diffusion can take place is no longer determined by the spacing between the two glass panes, but is limited to the much smaller cross-section in the gap between the spacer and the two glass panes. On the other hand, absorption of water vapor from the inner space of the insulating glass panel is not hindered, compared with a TPS® insulating glass panel, because the full, maximum cross-section is still available for that purpose, namely the entire surface, facing the inner space of the insulating glass panel, of the compound which contains the drying agent.
Compared with a TPS® insulating glass panel, a considerably smaller quantity of a compound containing a drying agent is required because the layer of that compound, which adheres to the inside of the section bar, is not required to contribute to the mechanical stability of the spacer or the mechanical bond between the glass panes in any phase of production and use of an insulating glass panel. Instead, this is the function of the primary sealing compound adhering to the flanks. The situation is different for a TPS® insulating glass panel because in this case the rope of the compound containing the drying agent must establish at least a provisional connection between the two separate glass panes. While the height of a TPS® rope typically is 8 to 12 mm, over the full width of the spacer, a layer having a thickness of 2 mm to 4 mm, depending on the desired absorptive capacity to water vapor and the desired sealing effect with respect to water vapor, is sufficient for the compound containing the drying agent applied on the inner surface of the spacer. Of course, a layer of greater thickness may be used, if desired.
Due to the fact that the compound containing the drying agent extends from the primary sealing compound on the one side of the spacer to the primary sealing compound on the other side of the spacer any untightness of the spacer will have no or only less disadvantageous effects on the sealing of the insulating glass panel. This is different for insulating glass panels of conventional design: Here, any untight points, such as pores or cracks or gaps, which meet especially in the area of the corners and in the area of the joint where the ends of the section bar forming the spacer join, will have disastrous effects because conventional secondary sealing compounds, which according to the prior art are the only material suited for covering such untight points of the spacer, cannot possibly prevent water vapor from penetrating into the system to the degree necessary to guarantee a service life of several years for the insulating glass panel.
Insulating glass panels of the kind where the outer surface of the spacer is not even covered by a secondary sealing compound (U.S. Pat. No. 5,439,716 A) would be unserviceable from the beginning if any untightness were to occur in the hollow-section bar from which the spacer is formed. On the other hand, an insulating glass panel according to the invention is tight even if the spacer should be untight.
The quality demands placed on section bars from which the spacers are formed can be reduced because now the section bars have to fulfill a mechanical function only, namely the function to keep the glass panes of the insulating glass panel at their predetermined spacing under the typical service conditions and loads, and to combine with one or more other sealing compounds. Consequently, it is possible to use very low-cost section bars which can be optimized to achieve minimum heat transfer. Even foamed section bars can be used which distinguish themselves by an especially efficient thermal insulation effect, while providing good mechanical stability.
The invention is suited for spacers of many different cross-sectional shapes, made from a variety of materials. Especially, the invention can be implemented with the aid of all usual section bars, conventionally used for frame-like spacers, including the frequently used hollow-section steel or aluminum bars and including metal or plastic sections of U-shaped or C-shaped cross-section, or metal sections of the kind known from DE 202 16 560 U1, for example.
Due to the application of a rope of a pasty material containing a drying agent no separate operation is needed to fill the hollow-section bars with a pourable drying agent, and there is also no need for devices serving to carry out that operation.
Compared with the situation existing with the insulating glass panel known from U.S. Pat. No. 6,470,561 B1, known under the trade name Intercept®, a separate operation in addition to the operation of coating the flanks of the spacer with a primary sealing compound, is needed for applying a matrix material with an embedded drying agent since in the case of the invention the compound containing the drying agent can be applied by a single operation together with the primary sealing compound; in fact, it is even possible to use one and the same sealing compound which then continuously extends from the one flank over the inner surface of the spacer to its other flank.
The compound containing the drying agent balances out any relative movements that may be caused by temperature variations due to different coefficients of expansion of the glass panes on the one hand and the spacer on the other hand.
Extraordinarily low heat transfer coefficients are achieved in the area of the spacer when the latter is made from a plastic material.
The compound extending from the one glass pane to the other glass pane may perform all the functions of a primary sealing compound in a conventional insulating glass panel: In addition to its main function to provide a barrier to water vapor as a primary seal, it may also serve as an assembly aid during assembly of the insulating glass panel by establishing a temporary connection due to the circumstance that it bonds the spacer to the two glass panes. And in addition, due to the embedded drying agent, there is also its capability of absorbing water vapor.
The invention provides advantages also under esthetic aspects: Unlike a striking glossy surface of a metal spacer, which preferably consists of aluminum and which will outshine any frame color, especially any darker frame color, a mat, dark or even black compound, interacting with the reflections encountered on the glass panes, will adapt itself to, and even reflect, the color of the respective window frame.
The section bar can be coated already prior to being formed into a frame-like spacer. This allows a very efficient linear operation with a minimum of machinery input.
All in all, the invention allows insulating glass panels to be produced at very low cost and with high quality, and is suited also, and especially, for efficient production of great quantities of insulating glass panels in standardized dimensions.

When lower demands are placed on the insulating glass panels, the compound containing the drying agent may be applied on the section bar so that is will come to lie adjacent the primary sealing compound applied on the flanks, without however being in direct contact with the latter. In any case, it is convenient in this case as well if the compound containing the drying agent extends over the full length of the inner surface of the spacer and especially over the inner surfaces of the corners.

A primary sealing compound may simultaneously serve as basis for the compound which contains the drying agent. And the two compounds also may be identical. For example, the compound containing the drying agent may be the same substance from which the thermoplastic spacer is formed in TPS® insulating glass panels. That polyisopropylene-based substance is well suited also for purposes of the invention. It may be employed also between the glass panes of the insulating glass panel and the flanks of the spacer, instead of a sealing compound which contains a drying agent. Further, it may be advantageous to use a primary sealing compound, for example a polyisobutylene, as a basis for the compound containing a drying agent and to concentrate the drying agent in the compound that faces the inner space of the insulating glass panel, while making the compound, which is applied on the flanks of the spacer, poor in or completely free from drying agents.

The combination of the compound containing a drying agent and the primary sealing compound, is applied onto the inner surface of the spacer in a width greater than the width of the spacer and covers even parts of the flanks of the spacer so that it will be compressed when the glass panes are pressed together so that it will form a flat layer adhering to the glass panes. For such compression to be performed, the compound containing a drying agent must not necessarily adhere to the inner surface of the spacer over the full area. Preferably, the combination of the compound containing a drying agent and the primary sealing compound is applied to the spacer and/or to a section bar forming the latter, so that its inner face, facing the inner space of the insulating glass panel, and an additional strip of the flanks are covered. This guarantees that during compression of the glass panes and the spacer the combination of the compound containing a drying agent and the primary sealing compound can be subjected to a pressure high enough, at least in the area of the flanks, to provide a full-surface bond to the spacer flanks on the one side and the glass panes on the other side. The combination of the compound containing a drying agent and the primary sealing compound thus provides at least a temporary bond between the glass panes and the spacer. If necessary, that connection is completed by a secondary sealing compound. The latter may extend, without any interruption, from the one glass pane over the outer surface of the spacer, to the other glass pane. In order to make the necessary mechanical connection durable, it will however be sufficient if the glass panes are connected indirectly by the secondary sealing compound. This can be effected by applying that compound in the form of two separate ropes, one of them connecting the spacer with the one glass pane and the other one connecting the spacer with the other glass pane. This helps save secondary sealing compound and reduces heat transmission in the area of the spacer.

In cases where the flanks of the spacer are flat and the gap between the flanks and the glass panes is substantially filled with the primary sealing compound or a combination of the compound containing a drying agent and the primary sealing compound, there is the possibility to apply a secondary sealing compound in the angle between the spacer outside and the respective neighboring glass pane and, especially, to give the surface of the compound the form of a groove. According to an especially preferred solution, the secondary sealing compound is provided only in the gap between the flanks of the spacer and the separate glass panes. This provides the advantage that the outside of the spacer may end flush with the edge of the glass pane with the effect that the useful light-transmitting area of the insulating glass panel will be increased and the depth up to which the edge of an insulating glass panel will be bordered by a window frame or a door frame, will be reduced. This has the result that the frames can be made particularly slender. In fact, it is even possible to make the outside of the spacer project beyond both sides of the spacer flanks and to cover the edges of the two glass panes by the projections so formed. This is a simple way of protecting the glass edges from splintering and the workmen who transport and install the insulating glass panels from injury. In the case of this advantageous development of the invention, the secondary sealing compound preferably extends into a gap between the projections of the spacer and the edges of the glass panes.

In an insulating glass panel according to the invention, the secondary sealing compound preferably is arranged directly adjacent the primary sealing compound or a combination of a compound containing a drying agent and a primary sealing compound. Since the primary sealing compound extends into the gap between the flanks of the spacer and the glass panes and since that gap has a small width, compared with the spacing of the glass panes, and may be sized solely under the aspect of a reliable sealing effect, the surface along which the primary sealing compound and the secondary sealing compound can contact each other, is small compared with the surface over which the primary and the secondary sealing compounds of a TPS® insulating glass panel are in contact one with the other. This already ensures that possible incompatibility reactions between the primary and the secondary sealing compounds will be of minor importance only. Still, it may happen that some substance, for example a plasticizer, may migrate from a sealing compound into the boundary surface between the primary and the secondary sealing compounds and may form a bubble in that area. This can, however, lead to untightness only if the bubble were to displace the primary sealing compound or the combination of a compound containing a drying agent and a primary sealing compound, or to detach it from the sealing surface. However, given the fact that the primary sealing compound extends into a narrow gap, this is almost excluded. In addition, the primary sealing compound or the combination of a compound containing a drying agent and a primary sealing compound can be securely retained in its predetermined position by establishing an interlocking connection between the compound and the spacer. This is the case in an advantageous further development of the invention. The positive connection between the primary sealing compound, or the combination of a compound containing a drying agent and a primary sealing compound, and the spacer preferably exists at the transition from the inner surface to the flanks of the spacer. A favorable solution is obtained when the positive connection is realized by giving the section bar, or the spacer formed from the latter, an undercut design over the full length of its flanks. That undercut, especially if configured as a dovetail, acts as abutment to prevent that during compression of the insulating glass panel the primary sealing compound or the combination of a compound containing a drying agent and a primary sealing compound present on the flanks may try to avoid the pressure. This is favorable with respect to the sealing effect in the gap between the spacer and the glass panes. Such an undercut configuration can be realized easily during production of the section bars, by injection molding of metal bars or extrusion of plastic bars, and need not necessarily increase the costs of the section bar. Especially well suited for this purpose is a positive connection in the form of a dovetail joint between the spacer and the primary sealing compound or the combination of a compound containing a drying agent and a primary sealing compound. The mechanical interlocking with the spacer then supplements the bonding effect of the primary sealing compound or the combination of a compound containing a drying agent and a primary sealing compound, thereby guaranteeing reliable bonding to the spacer even in the case of substantial temperature variations.

The section bars, from which the spacers are made, may be conventional hollow-section metal bars. Preferably, however, the hollow sections used consist of a plastic material as in this case sufficient mechanical stability, a low heat transfer coefficient and low costs can be realized at the same time. In this connection, no consideration needs to be given to the appearance of the section bar as the bar will anyway not be visible in the installed condition of the insulating glass panel.

The cross-sectional shape of the section bars from which the spacers are formed practically is not limited in the case of the invention as long as the spacer fulfils its main function to efficiently keep the two separate glass panes of an insulating glass panel at a spacing even under pressure and to combine with a compound containing a drying agent with the primary and, if necessary, also with the secondary sealing compound. The sections used may be hollow sections, U-sections, C-sections, mixed shapes of such sections and even solid sections without any cavity. Spacers made from hollow-section bars are especially preferred. They distinguish themselves by good mechanical stability even if their wall thickness is small. In the simplest of all cases, the hollow-section bar has a rectangular cross-section and the smallest height possible in order to keep the cost of materials and the heat transfer coefficient law. The minimum height is determined by the fact that the necessary compressive strength and security from tilting must be achieved and that the primary sealing compound or the combination of a compound containing a drying agent and a primary sealing compound, which is applied to the section bar must provide sufficient resistance to diffusion of water vapor into the insulating glass panel. Useful results are achieved already with a section bar having a height of 4 mm.

A favorable way of using a solid section is to make the section bar from a foamed plastic material that combines adequate mechanical stability with a low heat transfer coefficient and low cost.

Another possibility consists in forming the spacer from section bars which have a U-shaped cross-section but where, contrary to the prior art known from U.S. Pat. No. 6,470,561 B1, the back of the section forms the inside rather than the outside of the spacer. If not only the primary sealing compound or part of the combination of a primary sealing compound and a compound containing a drying agent but also the secondary sealing compound are applied onto the flanks of such a U-shaped section bar, as envisaged by the invention, then the inner space of the U section at the outside of the spacer can be kept completely free from any secondary sealing compound. Subsequent sealing of the insulating glass panel by application of a sealing compound may be convenient or necessary in this case only in the area of the corners of the spacer, if at all.

The invention is particularly well suited for insulating glass panels provided with one or more transoms. Insulating glass panels with integrated transoms have been known, for example, from DE 195 33 854 C1, DE 296 16 224 U1 and GB 2 242 699 A. The problem is the task to connect the transoms with the spacer in a durable and esthetically attractive fashion. This problem is solved especially by a further development of the invention where the spacers are provided with one or more recesses or openings on their inner surfaces. The recesses or openings are completely covered by the compound containing a drying agent and an additional interlocking between the spacer and the compound may be provided at the edges of the recesses or openings. The end pieces of the transoms, by which the latter are fixed on the spacer, can be passed through the compound containing a drying agent and into the recess or opening of the spacer located behind the compound where they may come to occupy a predetermined position which can be secured by a positive fit. The compound containing a drying agent advantageously also bonds to the end pieces thereby supporting the anchoring effect. Given the fact that the compound can be displaced into the recess or opening behind the compound, the end pieces further may foot on the compound without any disturbing gaps, the compound being supported by the spacer located underneath. One obtains in this way an attractive appearance of the point of fixation of the transom end pieces on the spacer and on the compound containing a drying agent.

The recesses or openings underneath the compound containing a drying agent preferably is closely adapted to the width of that portion of the end piece which is to be introduced, at least in transverse direction relative to the length of the section bar, so that the respective portion can be positioned and centered midway between the glass panes. Although the recesses or openings could also be adapted to the end pieces in the lengthwise direction of the section bar, it is preferred to use a continuous recess in the lengthwise direction, formed for example by the use of an injection molded or extruded bar of U-shaped or C-shaped cross-section. In lengthwise direction, it will be sufficient to fix the end portions of the transoms in the compound containing a drying agent, into which the end pieces are introduced.

In order to permit the points, where the transoms are to be fixed, to be found easily markings may be provided at the respective points of the section bars. Even more favorably, the surface of the compound containing a drying agent may be marked at the respective points, for example by an impression or by a mark applied using an ink jet printer.

Especially well suited for the assembly of transoms are spacers where the cross-section exhibits a plurality of chambers one of them, being located centrally between the flanks, being open toward the inner space of the insulating glass panels, at least in places, preferably however over its full length, and the opening or openings being covered by a compound containing a drying agent. It is possible in this way to obtain a spacer section of adequate stiffness and compressive strength, even with thin wall thicknesses, and to provide a chamber in the section which is accessible from the inner space of the insulating glass panel, which is closely adapted to the contour of the transom end piece to be fitted and which in addition comprises undercuts for interlocking with the transom end piece and with the compound containing a drying agent. Even with the cross-section of the open chamber closely adapted to the width of the transom end piece, the latter can displace the compound containing a drying agent into the open chamber because displacement can occur also in lengthwise direction of the section. This at the same time improves the fixing effect of the transom end pieces in lengthwise direction.

The contour of the flanks of the spacers may be selected, for example, in the way disclosed in U.S. Pat. No. 5,439,716 A. Good positional stability, combined with reduced consumption of secondary sealing compound and a smaller contact surface between the primary and the secondary sealing compounds, can be achieved if the spacer section is configured in such a way that the cross-section of the flanks exhibits a concave and/or undercut outer surface, onto which at least part of the primary sealing compound and the secondary sealing compound is applied. The layer thickness of the secondary sealing compound preferably is minimized at the edges of the concave surface area, and preferably the one edge of the concave surface area is followed by a flat surface area which is covered by the primary sealing compound or a combination of the primary sealing compound and a compound which contains a drying agent. Preferably, a further flat surface area is also provided adjacent the outer edge of the concave surface area. In the assembled condition of the insulating glass panel, the further flat surface area should be covered by the secondary sealing compound. The flat surface areas are the closest to the glass panes and support exact alignment of the spacer section between the glass panes, although exact alignment can be achieved also without any flat surface areas. Preferably, the flanks should by positioned especially close to the glass panes, at least in the neighborhood of the outside of the section and in the neighborhood of the inside of the section, which means that the width of the spacer section should be the greatest in these areas.

In an insulating glass panel according to the invention with rectangular contour, the spacer might be formed from four section bars connected via connection pieces that are bent off at a right angle. In this case, it has to be ensured that the primary sealing compound or the combination of a compound containing a drying agent and the primary sealing compound is applied in the corner areas without any interruptions. This can be achieved more easily if the spacer is provided with corners which, instead of using connection pieces, are formed by bending of a section bar. Accordingly, this solution is preferred for purposes of the invention. The process of bending metallic hollow sections or metallic U-sections to form a frame-like spacer for insulating glass panels is known in the art. But section bars made from plastic materials can be bent to form a frame-like spacer as well. More details are disclosed in DE 10 2004 005 354 A1 and in DE 10 2005 002 284 A1, to which reference is herewith made.

A section bar of adequately small height can already be bent, depending on the material from which it is made, when the bending point has been marked by forming a groove on the inside of the section bar, for example by a pressing operation, over the full width of the section bar. Bending may be facilitated by providing recesses on the outside and/or on the inside of the section bar, which recesses should extend over the full width of the section bar and may be produced by cutting operations. In this case, the primary sealing compound or the combination of a compound containing a drying agent and the primary sealing compound can be applied on the inside of the section bar without interruption, even in the corner area, prior to bending the section bar into the form of the corners; the bending operation is facilitated by the reduction of the material cross-section encountered in the corner area.

If the section bar consists of a foamed plastic material, which can be thermally deformed, for example due its content of thermoplastic components in addition to interlacing components which impart to it the required mechanical stability, then such a section bar can be compressed with the aid of a heated die at the point where the corner is to be formed, whereby the bending operation can be facilitated and at the same time the production of a solid corner can be supported.

There is further the possibility, both in the case of solid plastic sections and in the case of hollow sections, especially such made from plastic materials, to form two recesses at the point of the section bar where a corner is to be formed, by subjecting the section bar to a cutting operation. The recesses should be configured and arranged so as to define two projections which after bending of the corner engage into, especially snap into, the two recesses so that the legs of the spacers, which meet at the respective corner, are locked one to the other at a predefined angle. Examples of such an arrangement are disclosed in DE 10 2004 005 354 A1.

A method of producing an insulating glass panel according to the invention is defined in claim 34. The method starts by providing a section bar, which either is taken from a store or is produced immediately before being formed into a spacer, especially by injection molding or extrusion. If the frame-shaped spacer is to be joined from hollow-section bars using angled connection pieces, then the section bars are cut to the desired length, are coated with a compound containing a drying agent on the side of the spacer intended to become its inside, so that the compound as such, or in combination with a primary sealing compound, comes to cover the entire width of the section bar and to extend even beyond that width over part of the flanks of the spacer. Thereafter, the frame-like spacer is assembled from the coated section bars, and the lateral surfaces of the connection piece are additionally coated in the corner areas, if necessary.

However, if the spacer is to be formed from a section bar by bending, then the cutting and/or reforming operations necessary in the areas where the corners are to be produced are carried out before the section bar is coated, and coating of the section bar with the compound containing a drying agent and the primary sealing compound is carried out prior to the bending process. During bending of the section bar, the compound containing a drying agent and the primary sealing compound are simultaneously bent quite naturally. By connecting the ends of the section bar one with the other, the section bar so bent is then closed to form a frame-like spacer. This can be effected by fitting a straight connection piece in the two opposite joining ends of the section bar. The ends of the section bar may be truncated and may directly abut each other, or may abut a projection, especially a rib, on the connection piece. Or else, the ends of the section bar may be given shapes complementary one to the other for which purpose one or two projections are formed on the one end, which may be introduced into and fixed in, especially snapped into, one or two matching recesses on the other end of the section bar. More details in this respect are disclosed in DE 10 2004 005 354 A1.

In case an uninterrupted transition of the primary sealing compound should not be readily obtained at the abutment point, where the two ends of the section bar join each other, such uninterrupted transition can be realized by subsequent shaping of the primary sealing compound or by application of a smaller additional quantity of the primary sealing compound. An especially favorable solution is obtained when a wedge-shaped or notch-shaped recess, extending transversely to the long direction of the section bar, is provided on the inwardly facing side of the section bar at the point of abutment of the section bar, and is sealed subsequently. Injecting the sealing compound into such a recess produces a dynamic pressure which is favorable with a view to achieving a reliable sealing effect. Preferably, the point of abutment is then covered by a badge on the side of the section bar facing the inner space of the insulating glass panel, which makes the point of abutment practically invisible to an observer. Such a badge may consist of a label which may be stuck upon the surface of the compound containing a drying agent. Preferably, however, a rigid badge may be used, which may comprise one or more extensions on its bottom surface for being pressed into the compound containing a drying agent or—even better—right into a recess in the section bar covered by that compound, and this preferably without piercing the compound containing a drying agent. This then also guarantees the durable fit of the badge, provided the insulating glass panel will be properly installed so that the badge comes to lie at the upper edge of the insulating glass panel. Another advantage of the badge resides in the fact that it may carry a supplier trade mark and/or an inscription containing production data of the insulating glass panel.

Once the spacer has been coated and assembled with a combination of a compound containing a drying agent and a primary sealing compound, it is applied against a first glass pane so that it will adhere to it in the neighborhood of its edge. Thereafter a second glass pane is applied to the spacer in parallel arrangement to the first glass pane so that the second glass pane will likewise adhere to the spacer. The semi-finished insulating glass panel assembled in this way is then compressed to its desired thickness. Applying the spacer can be done by hand or mechanically. Devices suited for this task are known to the man of the art. And the operations of assembling and pressing insulating glass panels are likewise known to the man of the art. If the cohesion of the insulating glass panel achieved by the compound containing a drying agent and/or the primary sealing compound is of a temporary nature only, then the spacer will be finally connected with the two glass panes by application of a curable secondary sealing compound. This can be effected in a way known to the man of art, by applying the secondary sealing compound upon the outside of the spacer from the one glass pane to the other glass pane without any interruption. See for example DE 28 16 437 C2. Or else two separate ropes of the secondary sealing compound may be injected into two joints formed between the spacer and the two adjoining glass panes, as disclosed in U.S. Pat. No. 5,439,716 A, for example.

In the case of a substantially rectangular spacer profile it would further be possible to inject two ropes of the secondary sealing compound into the angle between the outside of the spacer and the two glass panes.

According to an especially efficient solution, the secondary sealing compound is likewise applied upon the flanks of the section bar from which the spacer is to be formed (independent claim 35). This way of proceeding is well suited especially for spacers which have their corners made by bending of a section bar. The compound containing a drying agent, the primary sealing compound and the secondary sealing compound may be applied in a single operation. If the secondary sealing compound is applied after application of the primary sealing compound, then the primary sealing compound and/or the compound containing a drying agent, having been applied on the flanks of the section bar, may act as a barrier that impedes the application of the secondary sealing compound, which is to be regarded as an advantage. The operations of forming the corners of the spacer and of closing the spacer, of applying the spacer to a glass pane, of applying a second glass pane and of compressing the insulating glass panel, may remain unchanged. There will be no separate sealing operation. This allows the process to be carried out in an especially efficient way, not only because one can do without a separate sealing operation, but also because the process of coating the spacer with a primary and with a secondary sealing compound can be carried out continuously, as a linear process. At the same time, a mark can be applied on the compound containing a drying agent in the predetermined areas where a transom is to be fixed.

If the secondary sealing compound is applied before the corners are bent, then it will be most convenient to leave a small strip of the flanks, adjoining the outside of the section bar, uncovered in order to permit gripping of the bar by its flanks during forming and closing of the spacer. The quantity of secondary sealing compound preferably is determined to ensure that the strip, which initially had been left free from secondary sealing compound, will be covered by displacement of the compound during compression of the insulating glass panel. Once the spacer has been closed, transoms can be fixed in the described way by introduction of their end pieces into the compound containing a drying agent or through the latter into a recess in the spacer.

A further advantage of the invention resides in the fact that interruptions during application of the secondary sealing compound can be tolerated because a firm mechanical connection will be guaranteed and tightness will be ensured to an outstanding degree by the compound filled with the drying agent and its special arrangement on the inside of the spacer, if necessary also on the flanks of the spacer.

Certain embodiments of the invention are illustrated in the attached drawings in which identical or corresponding parts are indicated by the same reference numerals. Further features and advantages of the invention will become apparent from the description of the examples.

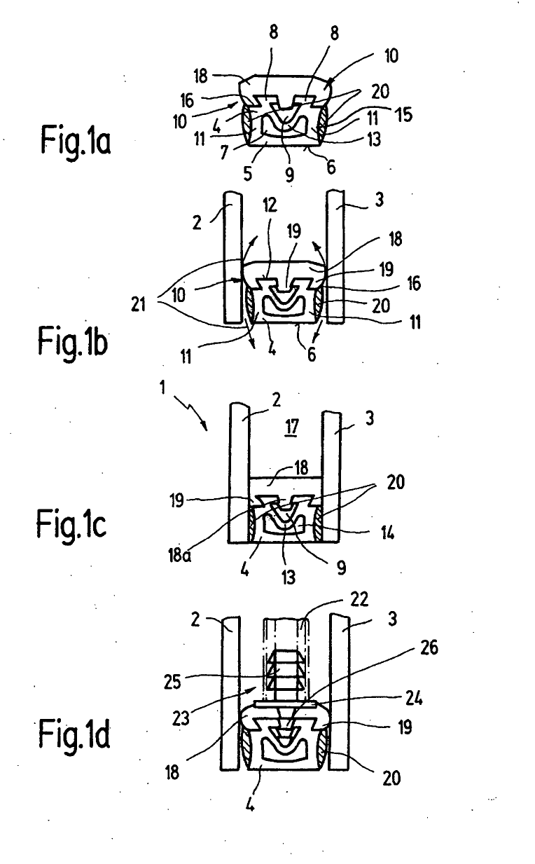

FIG. 1a shows a cross-section through a leg of a spacer coated with a primary and a secondary sealing compound;

FIG. 1b shows the leg of the spacer according to FIG. 1, mounted between two glass panes;

FIG. 1c shows the leg of the spacer according to FIG. 1b, after compression of the two glass panes to a predetermined thickness of the insulating glass panel formed from them;

FIG. 1d shows the arrangement of FIG. 1b, supplemented by a transom with a transom end piece;

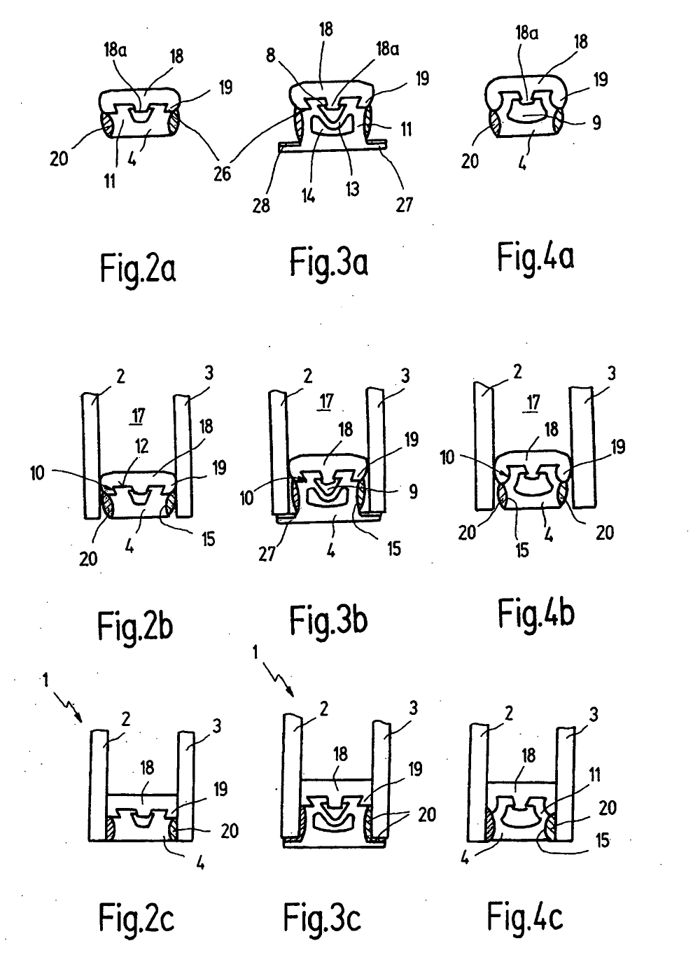

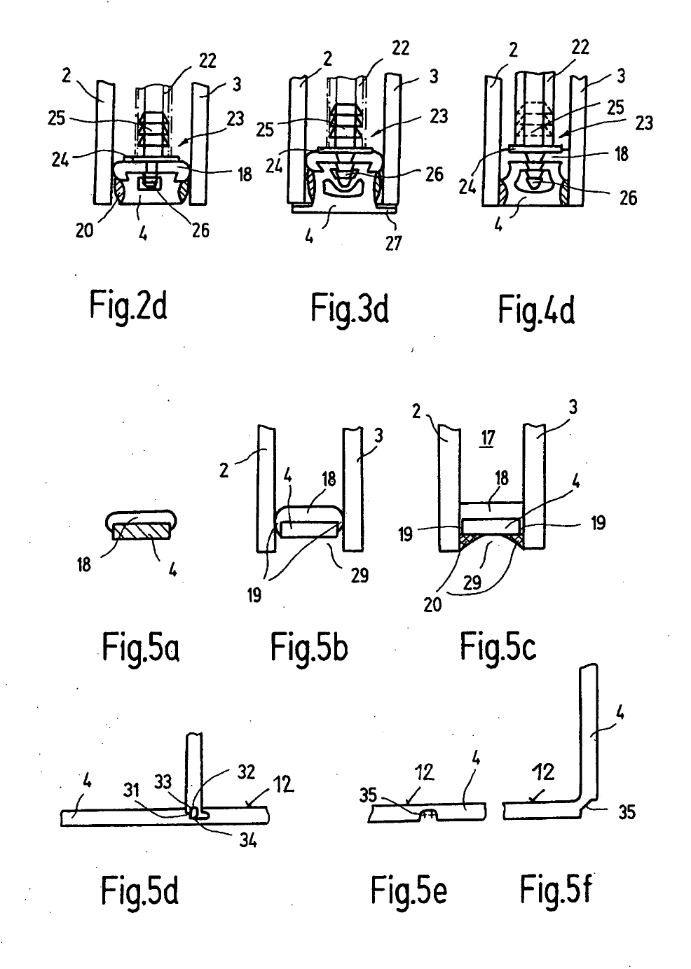

FIGS. 2a to 2d show representations similar to FIGS. 1a to 1d, with a second embodiment of a spacer, modified relative to FIGS. 1a to 1d;

FIGS. 3a to 3d show representations similar to FIGS. 1a to 1d, with a third embodiment of a spacer, modified relative to FIGS. 1a to 1d;

FIGS. 4a to 4d show representations similar to FIGS. 1a to 1d, with a fourth embodiment of a spacer, modified relative to FIGS. 1a to 1d;

FIGS. 5a to 5c show representations similar to FIGS. 1a to 1c, with a fifth embodiment of a spacer, modified relative to FIGS. 1a to 1c;

FIG. 5d shows a side view of a spacer of the kind illustrated in FIG. 5a, with a first embodiment of a corner;

FIGS. 5e and 5f show a side view of a spacer of the kind illustrated in FIG. 5a, with a second embodiment of a corner;

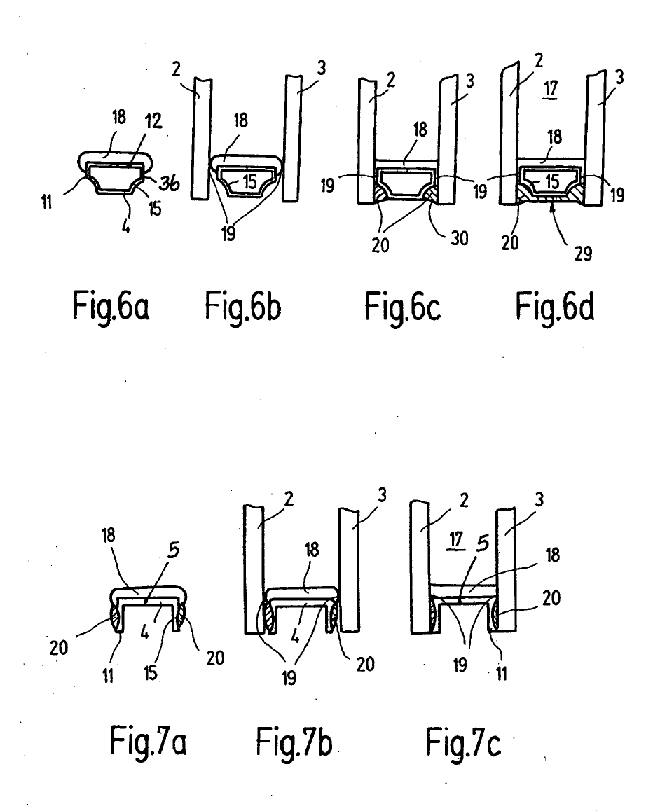

FIGS. 6a to 6c show representations similar to FIGS. 1a to 1c, with a sixth spacer modified relative to FIGS. 1a to 1c;

FIG. 6d shows part of a cross-section through an insulating glass panel, similar to the representation in FIG. 6c, where the secondary sealing compound is arranged to completely cover the spacer;

FIGS. 7a to 7c show representations similar to FIGS. 1a to 1c, with a seventh embodiment of a spacer, modified relative to FIGS. 1a to 1c;

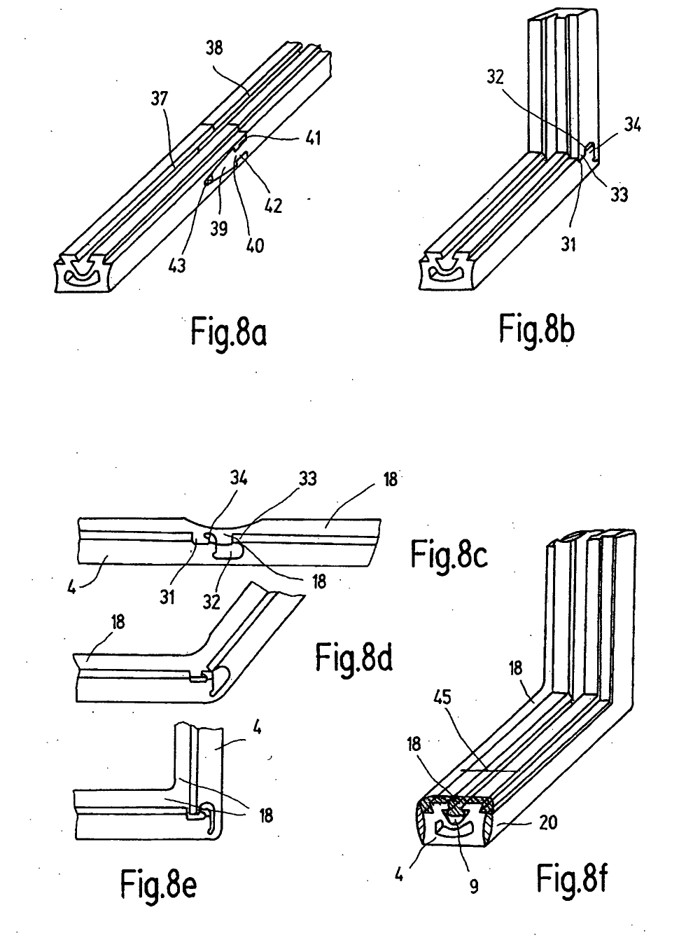

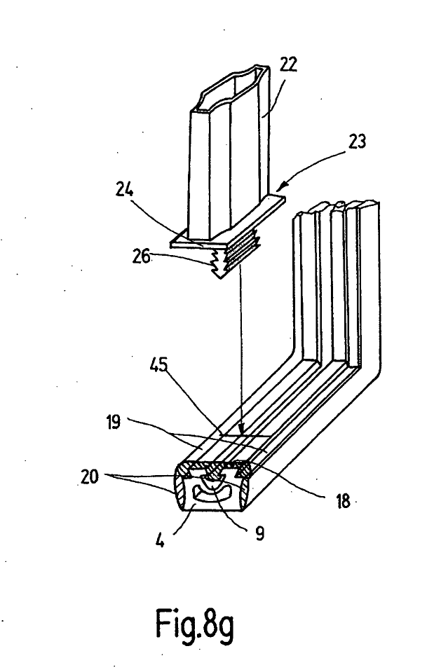

FIG. 8a shows an oblique view of a portion of a leg of a spacer of the kind illustrated in FIG. 1a, with a straight connection joint;

FIG. 8b shows a configuration of a corner of a spacer of the kind illustrated in FIGS. 1a and 8a;

FIGS. 8c to 8e show a partial side view illustrating three successive phases of the process of forming the corner illustrated in FIG. 8e, after the spacer section has been coated with a primary sealing compound;

FIG. 8f shows an oblique view illustrating a detail of a spacer similar to the one shown in FIG. 8b, but coated with a primary sealing compound and a secondary sealing compound;

FIG. 8g shows the operation of inserting a transom with a transom end piece into a spacer according to FIG. 8f;

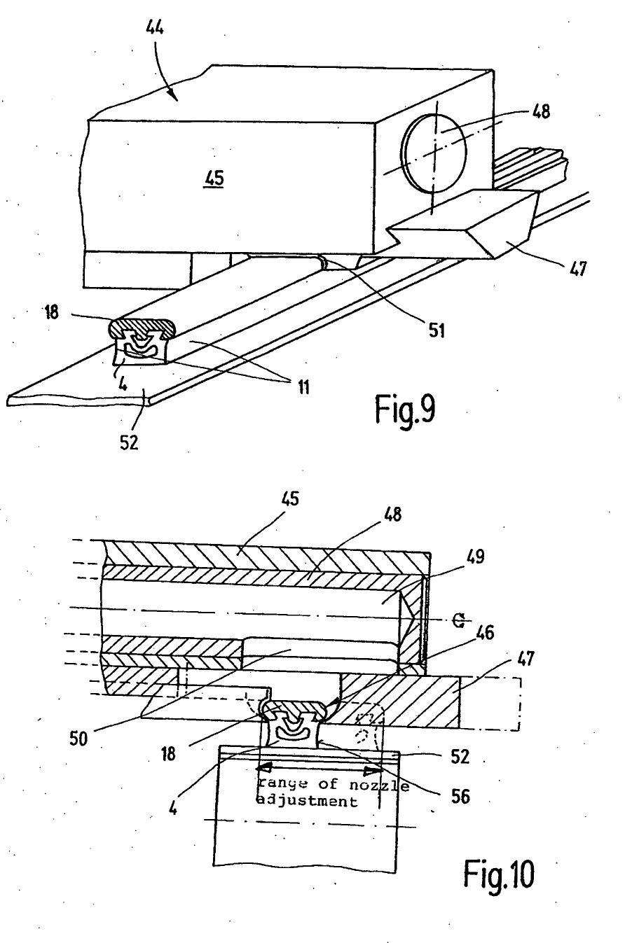

FIG. 9 shows an oblique view of a nozzle head for applying a primary sealing compound containing a drying agent upon a section bar of the kind illustrated in FIGS. 1a to 1d.

FIG. 10 shows a longitudinal section through the nozzle head of FIG. 9, sectioned at a right angle relative to the long axis of the section bar;

FIG. 11 shows a section similar to FIG. 10 of a modified nozzle head by means of which two differently composed compounds can be applied upon the section bar by coextrusion;

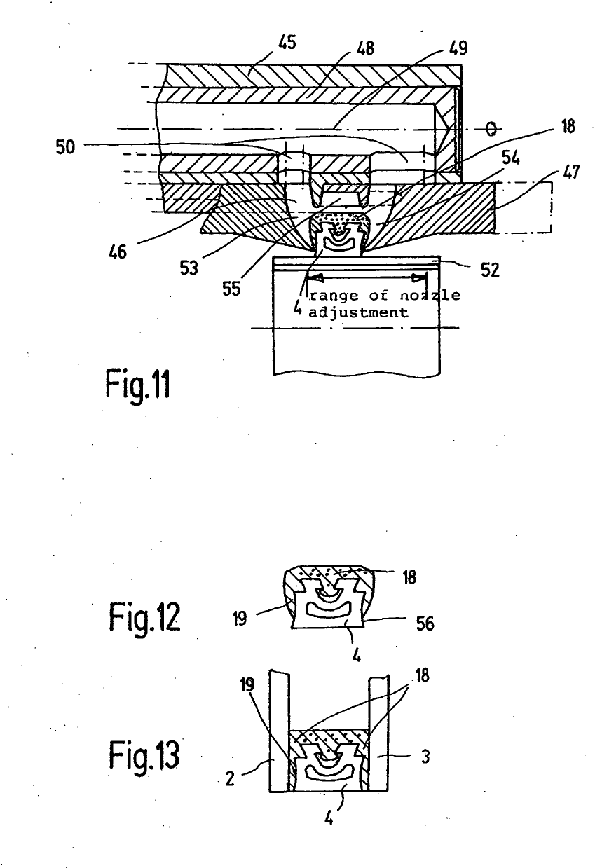

FIG. 12 shows a section through a section bar coated in this way;

FIG. 13 shows a section through part of an insulating glass panel produced in this way;

FIGS. 14 and 15 show representations similar to FIG. 12 and FIG. 13 of an embodiment modified relative to the embodiment mentioned above, with a single scaling compound with which the spacer section is to be coated on three sides;

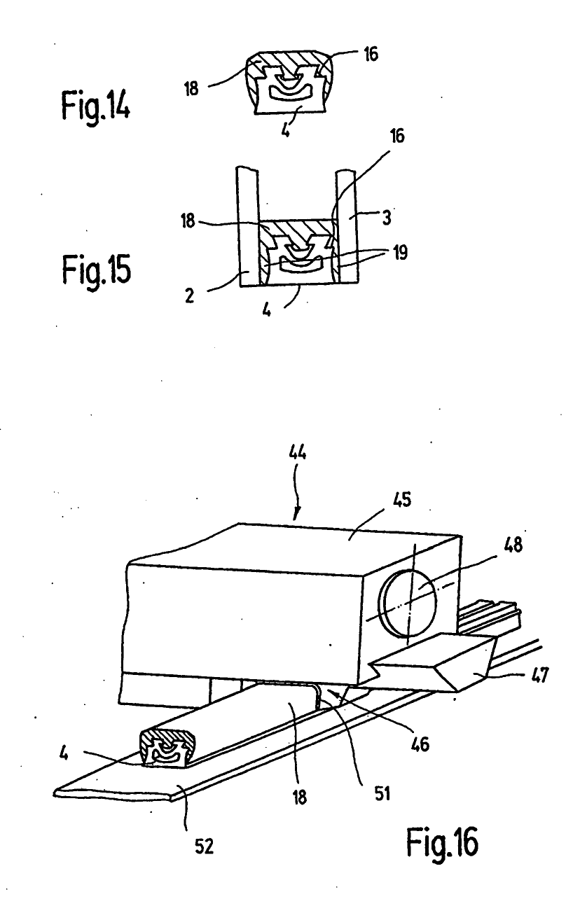

FIG. 16 shows an oblique view corresponding to that of FIG. 9, of a nozzle head suited for that purpose;

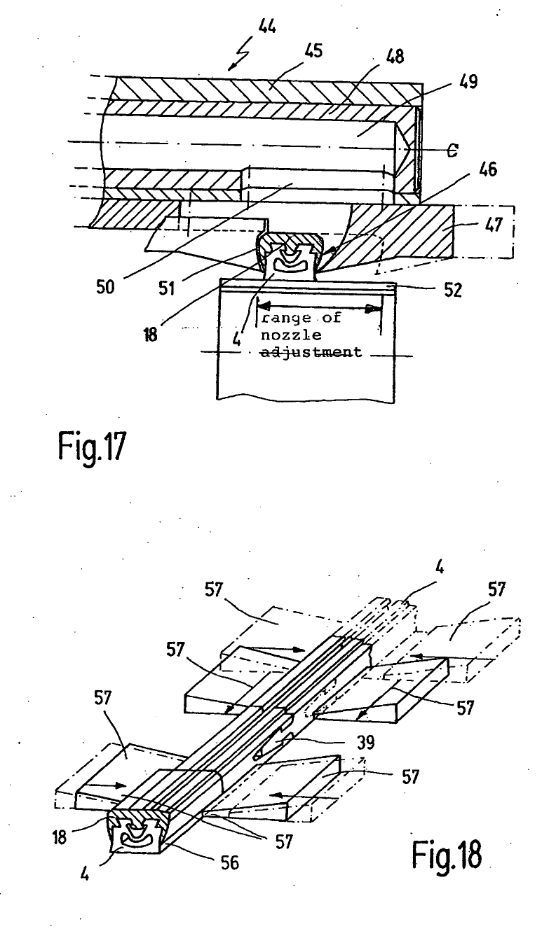

FIG. 17 shows a longitudinal section through the nozzle head of FIG. 16;

FIG. 18 shows means of connecting the end pieces of section bars that are to be connected by their ends in the way illustrated in FIG. 8a with the aid of clamping jaws;

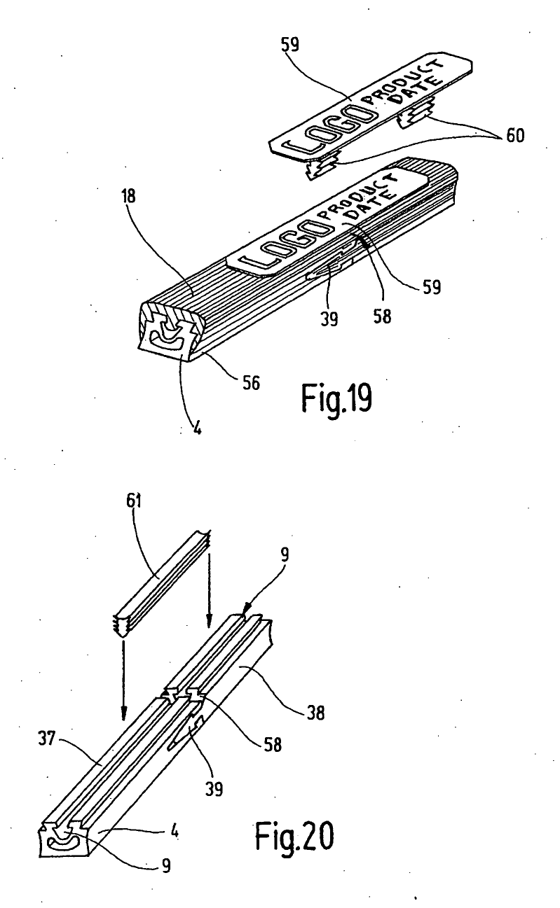

FIG. 19 shows an oblique view illustrating the attachment of a badge on the compound containing a drying agent on the side of the spacer facing the inner space of the insulating glass panel, in the area of a joint of the kind illustrated in FIG. 18;

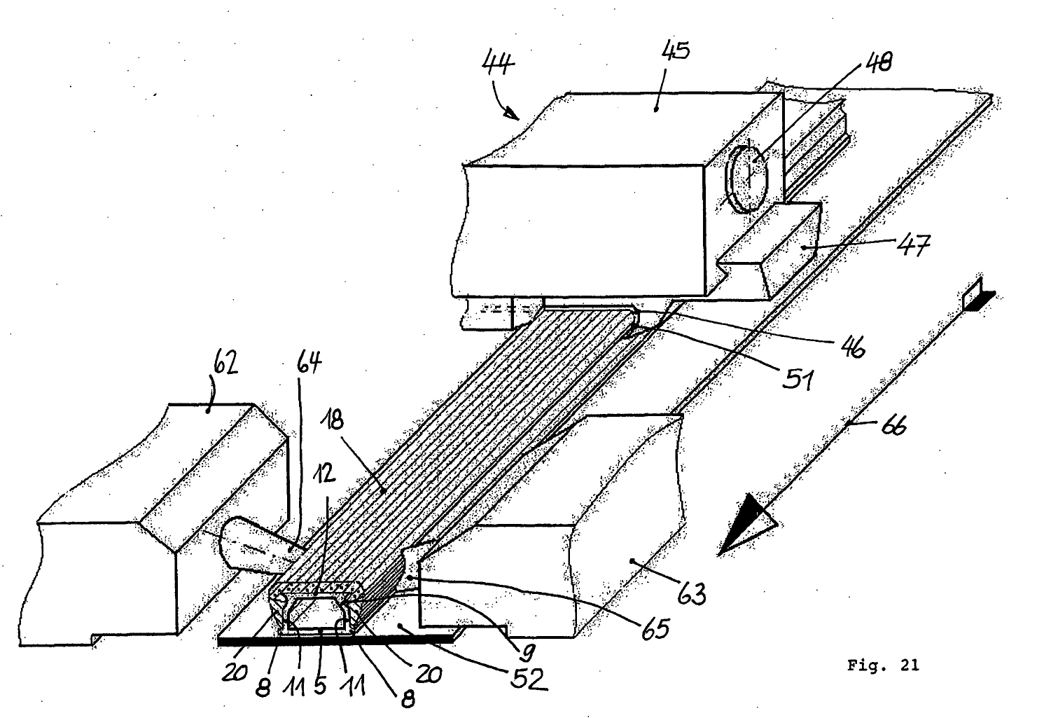

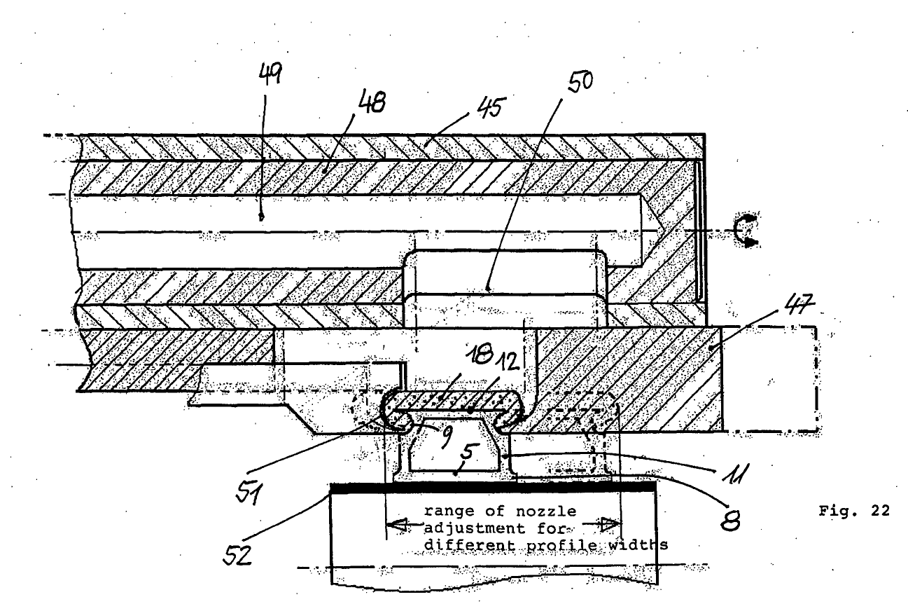

FIG. 20 shows an oblique view illustrating the way in which a joint of the kind illustrated in FIG. 18 can be secured by insertion of a wedge;

FIG. 21 shows an oblique view illustrating the arrangement of three nozzle heads for coating a hollow-section bar with two different sealing compounds;

FIG. 22 shows a section similar to that of FIG. 10 through a first one of three nozzle heads according to FIG. 21; and

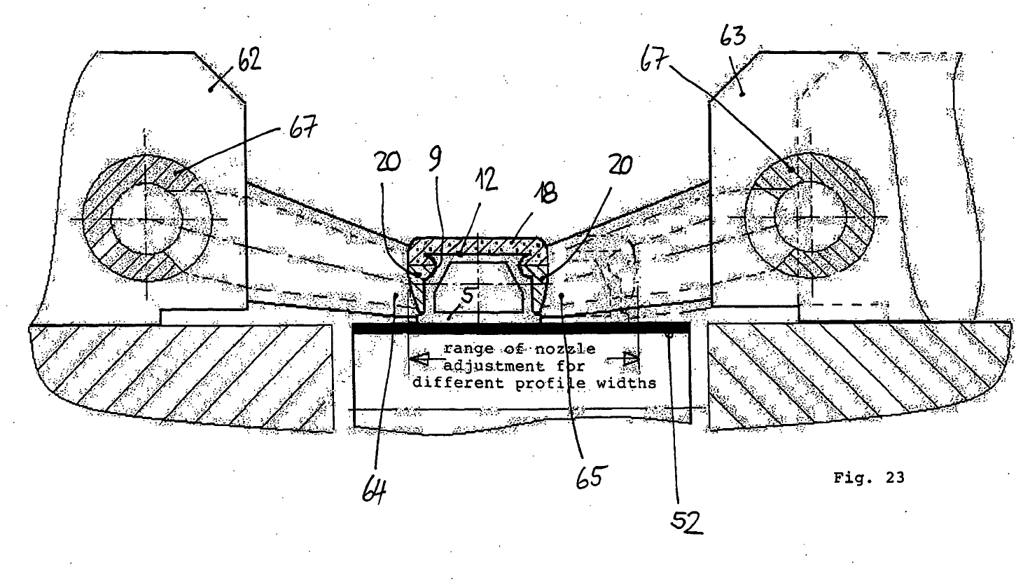

FIG. 23 shows a section through the section bar in the area of the two other nozzle heads.

FIG. 1c shows a detail of an insulating glass panel 1, illustrated separately in FIGS. 8a and 8b, which consists of two separate glass panes 2 and 3 with a frame-shaped spacer 4 located between the panes. The spacer 4 has a hollow profile in cross-section, which comprises a base 5 with a flat outside 6. Two mirror-symmetrical legs 11, issuing from the opposite inner surface 7 of the base 5, are provided with projections 8 directed toward each other on their ends remote from the end 5. The legs 11 form the flanks of the spacer 4, facing the panes 2 and 3. At their end remote from the base 5, the legs 11 are each provided with a lengthwise undercut 10. The two undercuts 10 together imitate the form of a dovetail. A partition wall 13, starting out from the location of the undercuts 10, approaches the base 5 along a curved path, up to the middle of the section, and together with the legs 11 and the base 5 defines a cavity 14. A V-shaped groove 9 formed between the projections 8 and the partition wall 13 is open toward the inner space 17 of the insulating glass panel, and the opening likewise has an undercut configuration, due to the projections 8. The outer surfaces of the legs 11 have a concave cross-sectional shape. The concave surface area 15 and the undercuts 10 are separated one from the other by a shoulder 16.

In order to form an insulating glass panel 8 using such a spacer 4, the spacer 4, or the section bar from which the spacer 4 is formed, is initially coated on its inner surface 12 with a bonding compound 18 in which a drying agent is embedded. The compound 18 extends from the shoulder 6 on the one side of the section bar without any interruption over the entire inner surface 12 and up to the opposite shoulder 16 and projects laterally beyond the flanks 11, which means that the compound 18 is applied in a width greater than the maximum width of the spacer 4, measured over the flanks 11—see FIG. 1a. In the described example, the compound 18 simultaneously serves as a primary sealing compound 19 which serves to seal the gap between the flanks 11 and the glass panes 2 and 3 and to temporarily bond the glass panes 2, 3 to the spacer 4. One then applies on each of the concave surface areas 15 a rope of a secondary sealing compound 20 of lentiform cross-section, as shown in FIG. 1a.

A spacer 4, coated in the described way, is applied to a first glass pane 2 so that it will adhere thereto at least with the aid of the bonding compound 18. Thereafter, the second glass pane 3 is applied to the free side of the spacer 4 so that it at least contacts the compound 18 which thereby comes to adhere to the second glass pane 3 as well, as illustrated in FIG. 1b. The two glass panes 3 and 4 are then compressed until the insulating glass panel to be formed therefrom reaches its predetermined thickness. Due to the selected contour of the compound 18 and of the secondary sealing compound 20 on their surfaces facing the glass panes 2 and 3, any trapped air can escape during this process through the gaps still existing at that time, as indicated by the flow arrows 21 in FIG. 1b. The compound 8 and the secondary sealing compound 20 are compressed until the predetermined thickness of the insulating glass panel 1 is reached, and form a two-dimensional sealing bond with the two glass panes 2 and 3, as illustrated in FIG. 1c.

The compound 8, containing a drying agent, which simultaneously serves as the primary sealing compound 18 may be formulated on a polyisobutylene basis with an embedded granular or powdery drying agent. Polyisobutylenes have thermoplastic properties and will not get brittle over time, but will maintain their good sealing effect. The secondary sealing compound 20 is a curable sealing compound, based for example on Thiokol or polyurethane or a silicon resin. Once cured, the compound, in combination with the spacer 4 having the necessary compressive strength, ensures the required durable mechanical and pressure-proof connection of the insulating glass panel 1. As the secondary sealing compound 20 is coated only on the flanks 11 of the spacer 4, the quantity required for this purpose is comparatively small. Further, the fact that the secondary sealing compound 20 is provided on a concave surface area 15 makes the surface area where the compound 18 and the secondary sealing compound 20 contact each other particularly small. This is an advantage with a view to limiting any incompatibility reactions between the compounds to an uncritical degree. Even if a reaction, for example formation of bubbles, should occur due to migration of components of one of the compounds 18, 20 in the area of the boundary surface between the compounds, such reaction will not cause the compound 18, which is important for the sealing effect, to get detached because that compound adheres not only to the glass panes 2 and 3, but also to the flanks 11 and the inner surface 12 of the spacer 4 with which it is additionally interlocked in the undercut areas 10 and behind the projections 8 by an extension 18a of the compound 18 extending behind the latter.

The size of the spacer 4 is adapted to the size of the glass panes 2 and 3 so that the outer surface 6 of the base 5 will end flush with the edge of the glass panes 2 and 3. In the case of stepped panels, where the two glass panes 2 and 3 have different sizes, the size of the spacer 4 most conveniently should be selected so as to ensure that the outer surface 6 of the base 5 will end flush with the edge of the smaller glass pane. The quantity of secondary sealing compound 20 preferably is selected to ensure that the material will fill the gap between the flanks 11 of the spacer and the two glass panes 2 and 3 as completely as possible, without however flowing over to the outside. The quantity and the contour of the sealing compound 18 containing a drying agent preferably are selected so as to obtain an almost flat surface on the side facing the inner space 17 of the insulating glass panel. The thickness of the compound 18 should, conveniently, not be less than 2.5 mm.

FIG. 1d shows a way in which a transom 22 can be placed in such an insulating glass panel 1. The transom 22 illustrated in FIG. 1d is configured as a hollow-section bar which is connected with an end piece 23 provided with a plate 24 narrower than the spacing between the glass panes 2 and 3 in the finished insulating glass panel (FIG. 1c). A first extension 25 extends from the one side of the plate 24 into the transom 22. A second extension 26 extends from the other side of the pate 24 through the compound 18 containing a drying agent and into the groove 9; by giving the second extension 26 a barb-shaped contour it is possible to make the extension snap behind the projections 8 so as to reliably fix it on the spacer 4. The barb-like contour of the first extension 25 can also render any displacement of the first extension 25 in the transom 22 more difficult. Undesirable movements of the transom 22 in the long direction of the spacer 4 are prevented by the compound 18 containing a drying agent on which the plate 24 rests and which encloses a second extension 26.

The embodiment illustrated in FIGS. 2a to 2d differs from the embodiment illustrated in FIGS. 1a to 1d insofar as it uses a spacer 4 with small cross-sectional height where the hollow space 14 and, accordingly, the partition wall 13 are omitted and to compensate for this the base 5 has been made somewhat thicker.

The embodiment illustrated in FIGS. 3a to 3b differs from the embodiment illustrated in FIGS. 1a to 1d insofar as both sides of the base 5 are provided with a projection 27 that extends below the edge of the glass pane 2 and the other glass pane 3, respectively. The projection 27 is provided with transverse ribs which rest against the edge of the glass panes 2 or 3, respectively. During compression of the insulating glass panel 1, the secondary sealing compound 20 may enter the spaces between the ribs 28 so as to fill the gap between the projections 27 and the lower edges of the glass panes 2 and 3, see FIG. 3c.

The embodiment illustrated in FIGS. 4a to 4d differs from the embodiments illustrated in FIGS. 1a to 1d insofar as the hollow space 14 and the partition wall 13 delimiting it have been omitted. In compensation, the base 5 has been made somewhat thicker. The groove 9 has been given a larger cross-section and a clear cross-sectional shape which now resembles a C instead of a V. The flanks 11 of the spacer 4 have been given a different contour by which an increased sealing depth compared with the first embodiment is ensured for the compound 18 containing a drying agent which simultaneously serves as the primary sealing compound to seal the insulating glass panel. The undercuts 10 are less marked.

The embodiment illustrated in FIGS. 5a to 5f differs from the embodiment illustrated in FIGS. 1a to 1d in that the spacer 4 is formed from a rectangular solid section of relatively small height, i.e. in that it does not have any hollow spaces. In the case of that sectional shape, a primary sealing compound 18, containing a drying agent, is applied to fully cover the inner surface 12 and to partially cover the flanks 11. A spacer 4 coated in this way is inserted between the two glass panes 2 and 3. When the latter are compressed, the primary sealing compound 18, containing the drying agent, is compressed and comes to completely fill the gap between the flanks 11 and the glass panes 2 and 3, as is illustrated in FIG. 5c. The size of the spacer 4 is somewhat smaller in this embodiment, compared with the size of the glass panes 2 and 3, so that there will still remain a marginal joint 29 between the glass panes 2 and 3, on the outer surface 6 of the spacer 4, into which two ropes of a secondary sealing compound 20 are injected following compression of the insulating glass panel 1, which ropes preferably do not contact each other and preferably form a concave surface 30 similar to a groove.

The spacer 4 exhibiting such a cross-section may be made from a rectangular solid section bar in which two continuous recesses 31 and 32 are formed, in the areas in which a corner is to be formed, by cutting operations, especially by drilling and milling, which recesses extend over the full width of the section bar, delimit two projections 33 and 34, which during bending of the section bar to form a corner engage into the one recess 31 and into the other recess 32, respectively, and are preferably locked therein for fixing the angle, especially a right angle, enclosed between the two legs of the spacer 4 at the respective corner. A more detailed description of the way in which such a corner is formed is provided by DE 10 2004 005 354 A1 and DE 10 2004 005 471 A1, to which reference is herewith made.

FIGS. 5e and 5f illustrate a further way of forming an angular spacer 4 with the aid of a solid section bar of rectangular cross-section, as illustrated in FIG. 5a. Here, a recess 35, extending up to approximately half the height of the cross-sectional height of the section, is formed by a cutting operation in the outer surface of the area of section bar where a corner is to be formed. The weakening of the section bar produced in this way now allows not only right angles but even angles smaller or greater than a right angle to be formed by bending so that it is possible in this way to produce spacers for model panes, for example for panes with a triangular or trapezoidal contour. The angles are then stabilized by closing the section bar to the form of a frame.

The embodiment illustrated in FIGS. 6a to 6c differs from the embodiment illustrated in FIGS. 5a to 5c in that the spacer 4 is made from a conventional hollow-section metal bar as disclosed, for example, in U.S. Pat No. 5,439,716. A primary sealing compound 18, containing a drying agent, extends over the inner surface 12 of the spacer 4 and, adjoining the latter, over a flat surface area 36 on the flanks 11 of the spacer 4, whereas the secondary sealing compound 20 is injected in the form of two ropes into a gap which widens in outward direction between the flanks 11 of the spacer and the glass panes 2 and 3, as illustrated in FIG. 6c. In the example illustrated in FIG. 6c, the contour of the spacer 4 is a little smaller than the contour of the glass panes 2 and 3, which enables a groove-like surface 30 to be formed for the secondary sealing compound 20.

The embodiment illustrated in FIG. 6d differs from the embodiment illustrated in FIG. 6c in that the contour of the spacer 4 is even a little smaller than in FIG. 6c so that a marginal joint 29 is obtained which is filled with the secondary sealing compound 20 to fully cover the outer surface 6 of the spacer 4.

In the examples of FIGS. 6a to 6d, a frame-like spacer 4 may be formed from hollow-section metal bars, as is known in the prior art, preferably by bending a hollow-section bar to the form of a frame-like structure where the two ends of the hollow-section bar come to face one another, and by connecting the two ends by means of a straight connection piece.

The embodiment illustrated in FIGS. 7a to 7c differs from the embodiment illustrated in FIGS. 1a to 1c in that the spacer 4 is formed from a section bar of U-shaped cross-section, the base 5 of which faces the inner space 17 of the insulating glass panel. The legs 11 of the spacer 4, adjoining the base 5, are provided with concave outer surfaces and are coated with a secondary sealing compound 20. A compound 18 containing a drying agent covers the whole base 5 and extends a certain distance over the lateral surfaces of the spacer 4 up to the edge of the concave surface area 15. Similar to the recess 35 in FIGS. 5e and 5f, an indentation or a recess, starting out from the outer edges of the legs and maintaining a distance to the base 5, may be formed in the legs 11, in the areas in which corners are to be formed. As can be seen in FIG. 5f, after bending of a corner, there will then remain a web between the recess 35 and the inner surface 12 of the spacer 4, which can be used for continuous coating of the flanks 11.

The spacers illustrated in FIGS. 1a to 5f preferably consist of plastic materials of the type from which section bars having the illustrated cross-sections are extruded. The spacers illustrated in FIGS. 6a to 6d may be made from usual hollow-section metal bars or from plastic materials. The spacer illustrated in FIGS. 7a to 7c likewise may be made from a plastic material or from metal.

If it is desired to produce frame-like spacers 4 with bent corners from straight sections, where the circumference of the frame is greater than the length of a single section bar, then two section bars must be connected in linear fashion. A further connection must be made at the point where two section bar ends join each other from opposite sides after bending of the spacer 4. One possibility to connect two section bar ends 37 and 38 without the use of a separate connection piece is illustrated in FIG. 8a. For this purpose, one first reshapes the blunt ends of the section bars 37 and 38, especially by a cutting operation:

For example, a wedge-shaped projection 39, provided with an undercut 40, is cut out by milling from each leg 11 at the one end 38 of a section bar. The undercut 40 delimits two recesses 41 and 42 which in their turn delimit a neck of the wedge-shaped projection 39. Two recesses 43, adapted to the wedge-shaped projections 39 and having a similar wedge-shaped form but a somewhat greater length than the projections 39 are then formed on the other end 37 of the section bar. The recesses 43 are undercut to conform with the wedge-shaped projections 39. This allows the two section bar ends 37 and 38 to be fitted one in the other by introducing the wedge-shaped projections 39 into the recesses 37 and by positively locking them one in the other, whereby the connection illustrated in FIG. 8a is obtained. The gap between the two section bar ends 37 and 38 remaining at the joint is then covered by coating the full width with a primary sealing compound 18 containing a drying agent, so that it cannot possibly lead to untightness of the insulating glass panel. These and other ways of connecting two section bar ends in linear fashion are disclosed in DE 10 2004 005 471 A1, to which reference is herewith made.

FIG. 8b shows a way of forming a corner in a spacer 4, formed from a section bar having the cross-section illustrated in FIGS. 1a to 1d and in FIG. 8a. The scheme of forming the corner is the same as the one illustrated in FIG. 5d:

Two recesses 31, 32 are formed in the area of the section bar where a corner is to be formed, which recesses delimit two projections 33, 34 that engage into the recesses 31, 32 during bending of the corner and lock the two adjoining legs at a right angle. The process of forming such corners is described in detail in DE 10 2004 005 354 A1, to which reference is herewith made for further detail.

FIG. 8b shows the spacer 4 in uncoated condition so that the configuration of the corner can be seen more clearly. In practice, however, the procedure is to first produce the recesses 31, 32 and the projections 33, 34 delimited by them, by cutting operations performed on a straight section bar, in the areas in which the corners are to be formed. Thereafter, the section bar, still in its straight condition, is coated with a primary sealing compound 18 containing a drying agent over its full or almost its full length. Preferably, the section bar is also coated with a secondary sealing compound 20 at this point. The coating of the primary sealing compound 18 containing a drying agent is preferably made thinner in the area of the corner, as illustrated in FIG. 8c, so that it will not fold unsightly during bending of the corner (FIG. 8d and FIG. 8e). FIG. 8f shows an oblique view illustrating a detail of the spacer 4 in the area of a corner already bent, which is coated with both a primary sealing compound 18 containing a drying agent, and a secondary sealing compound 20.

As illustrated in FIG. 8g, transoms 22 can be fitted in such a spacer 4. For this purpose, a marking 45 is applied at the points where a transom 22 is to be fixed. The marking may be a groove pressed into the upper surface of the primary sealing compound 18 containing a drying agent, or a marking applied with the aid of an ink jet printer, for example. The transom 22 can then be fixed at this point by hand, as has been described above.

The nozzle head 44 illustrated in FIGS. 9 and 10 comprises a housing 45, with a rotary slide valve 48 seated in the housing and a supply line 49 for a primary sealing compound 18 containing a drying agent running through the valve. The rotary slide valve 48 is arranged closely above the orifice 46 of the nozzle head 44. In the open condition of the nozzle head, illustrated in FIG. 10, the supply line 49 communicates with the orifice 46 of the nozzle head 44 via an opening 50 of the rotary slide valve 48. The orifice 46 has a contour 51 which determines the contour the primary sealing compound 18 containing a drying agent will have on the section bar. The clear opening of the orifice 46 can be adapted to section bars of different widths by a slide 47. In the stationary condition of the nozzle head 44, the section bar may be run transversely through the orifice 46, using a horizontal conveyor 52, being coated continuously during that operation.

The nozzle head 44 illustrated in FIG. 11 differs from the nozzle head illustrated in FIGS. 9 and 10 in that the orifice 46 of the nozzle is supplied by three channels 53, 54 and 55, the outer channels 53 and 54 being directed against the two flanks 11 of the section bar, whereas a central channel 55 is directed against the inner surface of the section bar which will face the inner space 17 after installation in an insulating glass panel. The channels 53 and 54 are supplied via a common supply line 49, whereas the channel 55 is supplied via a separate supply line parallel to the supply line 49, which extends in parallel to the supply line 49 in the rotary slide valve 48, but behind the drawing plane of FIG. 11 so that it cannot be seen in the drawing.

The channels 53 and 54 serve to supply a primary sealing compound, free from drying agent, whereas the channel 55 serves to supply a compound containing a drying agent which—apart from the drying agent—may consist of the same substance as the primary sealing compound, or of a different pasty adhesive substance. Using such a coextrusion nozzle it is possible to produce a coating on three sides of the section bar, as illustrated in FIG. 12, which coating will be substantially free from drying agent on the flanks 11 but will contain a drying agent on the side 12 which later will face the inner space 17 of the insulating glass panel. A coating of secondary sealing compound 19 is not envisaged for the flanks 11. Therefore, the primary sealing compound applied in this area comprises reactive components that will lead to sufficiently firm interlacing of the sealing compound and to a bond with the glass panes 2 and 3 on the one side and the spacer 4 on the other side. For example, the primary sealing compound 19 may be a reactive hot-melt. The compound 18 containing a drying agent may be a polyisobutylene-based sealing substance, for example. Between the compound 18 containing a drying agent and the primary sealing compound 19 intimate interlocking occurs as the different substances are combined already in the orifice 46 of the nozzle head 44. In this way it is also possible to coat a spacer 4 as illustrated in the examples of FIGS. 1a to 5c and 6a to 7c.

The use of a single sealing compound instead of a combination of a primary sealing compound and a secondary sealing compound is possible in all cases where the single sealing compound ensures adequate sealing from diffusion of water vapor—as is the case with a conventional primary sealing compound, such as a polyisobutylene—and at the same time allows a sufficiently tension-proof and pressure-proof connection to be achieved between the glass panes and/or with the spacer—as is the case with a conventional secondary sealing compound, such as a polysulfide (Thiokol). It is then also possible to embed the drying agent, especially in the form of a powder, in such a uniform sealing compound so that a single substance only will be required for the complete coating of the spacer. It is understood that the different possibilities of coating a spacer are applicable to the different sections, especially the sections according to FIGS. 1a to 7d.

FIGS. 14 and 15 show an embodiment that differs from the embodiment illustrated in FIGS. 12 and 13 in that the spacer 4 is uniformly coated on three sides by the same material, which has both the properties of a primary sealing compound and interlacing, binding components that lead to an adequately firm bond of the insulating glass panel. In addition, the material in its entirety contains a preferably powdery drying agent. For producing such a coating on the spacer 4, a nozzle head 44 is needed whose orifice 46 has the contour illustrated in FIG. 11 and which is supplied via a single supply line 49, as illustrated in FIGS. 16 and 17.

In the case of the section bars that are coated in accordance with FIGS. 9 to 17, an uncoated strip 56 preferably remains on the flanks 11, in the immediate neighborhood of the outer surface 6 of the base 5. This strip 56 can be used—as illustrated in FIG. 18—for gripping the section bar by means of pairs of clamping jaws 57, so that the two section bar ends to be connected one with the other can be joined by approaching the two pairs of clamping jaws 57 one to the other. In addition, it is illustrated in FIG. 20 that a groove-like recess 58 is provided in the area of the joint, which extends over the full width of the spacer section on its inner surface 12 to be coated. In the area of that recess 58, the joint is subsequently sealed by injecting a sealing compound in order to achieve an uninterrupted and tight coating in the long direction of the section bar. This can be effected using a nozzle head which in principle has the same structure as the nozzle heads illustrated in FIGS. 9, 10, 11, 16 and 17, although the orifice can be made narrower to conform to the gap that remains to be closed. By displacing the section bar in the orifice of the nozzle, before the latter is opened to release the section bar, the desired contour of the sealing compound can be obtained at the joint as well.

In order to make the joint in the insulating glass panel less visible, it is preferably covered by a badge 59, as illustrated by way of example in FIG. 19. In the illustrated example, the rear surface of the badge 59 is provided with two extensions 60 which can be passed through the compound 18 containing a drying agent, and into the groove 9 located underneath, for being anchored in it. At the same time, the extensions 60 prevent any lateral movement of the two joined ends of the section bar, one relative to the other, during further handling of the frame-like spacer 4. Where such a badge 59 is undesirable, lateral displacement between the two section bar ends may be prevented also by fitting a wedge 61 in the groove 9, as illustrated in FIG. 20. The wedge 61 is then covered by the compound 18, containing a drying agent.

The wedge 61 and the extensions 60 of the badge 59 may also be provided with barbs that counteract any effort to pull the section bar ends apart. In this case, the section bar ends need not engage each other in complementary form, as is illustrated for example in FIG. 8a, but may instead be connected by a butt joint. This is likely to simplify the connection of the section bar ends.

Alternatively, it may be of advantage to make the extensions on the badge 59 so small in height that they cannot possibly pierce the compound 18 containing a drying agent. This is especially advantageous with a view to preventing water vapor diffusion.

FIGS. 21 to 23 show a modified embodiment and arrangement of nozzle heads 44, 62, 63 by means of which two differently composed compounds are coextruded onto a hollow-section bar from which a spacer 4 will be formed later. In contrast to the embodiment according to FIG. 11, where the two different compounds are extruded from a single nozzle head having three outlets communicating with three channels 53, 54, 55, FIG. 21 shows a first nozzle head 44 which serves to apply a compound 18 containing a drying agent onto a hollow-section bar and a second nozzle head 62 and a third nozzle head 63 provided with oppositely arranged nozzles 64 and 65 that are directed toward the flanks 11, through which a secondary sealing compound 20 can be applied upon the flanks 11. The hollow-section bar lies on a horizontal conveyor 52 which moves in the direction of arrow 66 and which transports the hollow-section bar initially past the first nozzle head 44 and then through the two nozzles 64 and 65 which are spaced from the first nozzle head 44 by a few centimeters or some ten centimeters, for example. The compound 18 containing a drying agent and the secondary sealing compound 20 are coated in overlapping fashion, with respect to time, the operation of coating the flanks 11 with the secondary sealing compound 20 occurring after the operation of coating the spacer 4 with the compound 18 containing a drying agent, on the side which later becomes the inner surface 12 of the spacer 4. Given the fact that, normally, the secondary sealing compound 20 and the compound 18 containing a drying agent are different in consistency and viscosity, application with the aid of separate nozzles 44, 62, 63 can be effected and controlled more efficiently than in the case of a multiple nozzle of the kind shown in FIG. 11.

The structure of the first nozzle head 44 in FIG. 21 and FIG. 22 corresponds in principle to the structure of the nozzle head 44 in FIG. 9 so that reference can be made in this respect to the description of FIG. 9. The difference to FIG. 9 essentially lies in the fact that the contour 51 of the orifice 46 of the first nozzle head 44 has been adapted to the different shape of the hollow-section bar. In the embodiment of FIGS. 21 to 23, the hollow-section bar consists of a plastic material or of metal and comprises a flat base 5 with lateral projections 8. Upright flanks 11 issuing from the base 5 are connected by a wall which later forms the inner surface 12 of the spacer. The flanks 11 project vertically from the base 5, and their upper portion forms a groove 9 on both sides of the hollow-section bar, whereby an undercut is produced into which the compound 18 containing a drying agent will be extruded from above—see FIG. 21 and FIG. 22. The secondary sealing compound 20 is coated onto the flanks 8 immediately adjacent the compound 18 containing a drying agent.

The second nozzle head 62 and the third nozzle head 63 each comprise a rotary slide 67 which selectively opens or closes supply lines to the nozzles 64 and 65, which latter are supplied via a pump and lead into the nozzle heads 62, 63, respectively. The projections 8 of the base 5 delimit the coating of the secondary sealing compound 20 in downward direction.

The compound 18 containing a drying agent and the secondary sealing compound 20 can be fed and applied in quantity-controlled fashion, depending on the speed of the horizontal conveyor 52. Such controls are known in the field of insulating glass panel production.

The two nozzle heads 62 and 63 can be approached to and moved away from each other, for being advanced to the section bar and adapted to different section widths.

When a secondary sealing compound 20 is applied by the nozzles 64 and 65, which only produces a firm bond in the insulating glass panel, without however producing the required water vapor barrier, then the compound 18 containing a drying agent must simultaneous perform the function of a primary sealing compound that ensures the required water vapor tightness. In this case, the compound in which the drying agent is embedded may be a polyisobutylene or a TPS® material. Known TPS materials are likewise based on a polyisobutylene. The secondary sealing compound 20 used may be a Thiokol, a polyurethane or, for example, a reactive hot-melt that will interlace after coating.

### LIST OF REFERENCE NUMERALS

1. Insulating glass panel

2. Glass pane

3. Glass pane

4. Spacer

5. Base

6. Outside of 5

7. Inside of 5

8. Projections

9. Groove

10. Undercut

11. Flanks, legs of spacer

12. Inside of spacer

13. Partition wall

14. Hollow space

15. Concave surface area

16. Shoulder

17. Inner space of insulating glass panel

18. Compound containing a drying agent

18a. Extension of 18

19. Primary sealing compound

20. Secondary sealing compound

21. Flow arrows

22. Transom

23. End piece

24. Plate

25. First extension of 23

26. Second extension of 23

27. Ribs

28. Ribs

29. Marginal joint

30. Concave, groove-like surface

31. Recess

32. Recess

33. Projection

34. Projection

35. Recess

36. Flat surface area

37. Section bar end

38. Section bar end

39. Wedge-shaped projection

40. Undercut

41. Recess

42. Recess

43. Recess

44. Nozzle head

45. Housing

46. Orifice

47. Slide

48. Rotary slide valve

49. Supply line

50. Opening of the rotary slide valve

51. Contour of 46

52. Horizontal conveyor

53. Channels

54. Channels

55. Channels

56. Uncoated strip

57. Clamping jaws

58. Groove-like recess

59. Badge

60. Extension

61. Wedge

62. 2^{nd} nozzle head

63. 3^{rd} nozzle head

64. Nozzle

65. Nozzle

66. Arrow

67. Shut-off rotary valve

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. Insulating glass panel in which two separate glass panes are kept at a distance by a spacer formed from a section bar, which has an inner surface, an outer surface and two flanks, a drying agent is provided in combination with the spacer, and a gap is provided on both sides of the spacer between the spacer and the two glass panes which gap is sealed by a primary sealing compound that adheres to the spacer and to the glass panes, wherein a compound, which contains a drying agent, is arranged beside the primary sealing compound that seals the two gaps, on the side of the spacer, hereinafter also described as the inside, that faces the inner surface of the insulating glass panel, the section bar having a hollow section.

67. The insulating glass panel as defined in claim 1, wherein the compound, which contains the drying agent, is arranged adjacent the primary sealing compound that seals the two gaps, on the side of the spacer facing the inner space of the insulating glass panel so that it covers the inside to the extent the latter is not already covered by the primary sealing compound.

68. The insulating glass panel as defined in claim 66, wherein the compound adheres to the spacer.

69. The insulating glass panel as defined in claim 66, wherein compound adheres to the primary sealing compound.

70. The insulating glass panel as defined in claim 66, wherein the compound containing the drying agent is positively interlocked with the spacer.

71. The insulating glass panel as defined in claim 70, wherein the positive connection between the compound containing the drying agent and the spacer exists at least at the transition from the inside to the flanks of the spacer.

72. The insulating glass panel as defined in claim 70, wherein for forming the positive connection the section bar has an undercut configuration over its full length.

73. The insulating glass panel as defined in claim 72, wherein the positive connection between the spacer and the compound containing the drying agent is configured in the way of a dovetail connection.

74. The insulating glass panel as defined in claim 66, wherein the primary sealing compound in the gap between the flanks and the glass panes is free from drying agent or contains a lesser concentration of drying agent than the compound containing a drying agent, present on the inside of the spacer facing the inner space of the insulating glass panel.

75. The insulating glass panel as defined in claim 66, wherein a curable secondary sealing compound is provided which connects the two glass panes directly or indirectly with the spacer in an area closer to the outside than the primary sealing compound, and that produces a durable and stable bond between the glass panes.

76. The insulating glass panel as defined in claim 75, wherein two separate ropes of the secondary sealing compound are provided, the one rope of which connects one glass pane while the other rope connects the other glass pane with the spacer.

77. The insulating glass panel as defined in claim 76, wherein the secondary sealing compound is provided only in the gap between the flanks of the spacer and the respective glass pane facing the flank.

78. The insulating glass panel as defined in claim 76, wherein the flanks have a concave outer surface in cross-section.

79. The insulating glass panel as defined in claim 78, wherein the concave outer surface is delimited on both sides by a flat surface area, the primary sealing compound extending to one of the flat surface areas adjacent the inside of the spacer.

80. The insulating glass panel as defined in claim 66, wherein the section bar consists of a plastic material.

81. The insulating glass panel as defined in claim 66, wherein the section bar has a rectangular cross-section.

82. The insulating glass panel as defined in claim 81, wherein the width of the section bar is greater than its height.

83. The insulating glass panel as defined in claim 80, wherein the section bar has a box section.

84. The insulating glass panel as defined in claim 66, wherein the section bar is open in places on its inside, the openings being covered by the compound containing the drying agent.

85. The insulating glass panel as defined in claim 66, in which at least one cross bar is arranged and fixed on the spacer by end pieces, wherein the end pieces engage through the compound into a recess or opening in the spacer located behind the compound.

86. The insulating glass panel as defined in claim 85, wherein the recess or opening in the spacer is closely adapted to the width of the end piece at least in a direction transverse to the long direction of the section bar.

87. The insulating glass panel as defined in claim 66, wherein the outside of the spacer ends flush with the edge of the glass panes.

88. The insulating glass panel as defined in claim 87, wherein the outside of the spacer comprises projections projecting on both sides beyond the flanks of the spacer and covering the edge of the two glass panes.

89. The insulating glass panel as defined in claim 87, wherein the secondary sealing compound extends up to the area between the projections of the spacer and the edge of the glass panes.

90. The insulating glass panel as defined in claim 66, wherein the spacer comprises corners that are formed by bending of the section bar.

91. The insulating glass panel as defined in claim 90, wherein the section bar is provided, at one corner of the frame-shaped spacer, with at least one recess that extends over the entire width of the section bar.

92. The insulating glass panel as defined in claim 91, wherein at least one recess is provided on the outside.

93. The insulating glass panel as defined in claim 91, wherein two recesses delimit two projections at the corner, which projections engage each other after bending and lock the legs of the spacer, joining each other at the corner, at a definite angle.

94. Method of producing an insulating glass panel in which two separate glass panes are kept at a distance by a spacer formed from a hollow section bar, which has an inner surface, an outer surface and two flanks,
a drying agent is provided in combination with the spacer,
and a gap is provided on both sides of the spacer between the spacer and the two glass panes which gap is sealed by a primary sealing compound that adheres to the spacer and to the glass panes,
a compound, which contains a drying agent, is arranged beside the primary sealing compound that seals the two gaps, on the side of the spacer, hereinafter also described as the inside, that faces the inner surface of the insulating glass panel, comprising the steps of:
(a) Providing a section bar having a hollow cross-section;
(b) applying a compound containing a drying agent, on the section bar, on the side of the spacer which later forms the inside of the spacer and
applying a primary sealing compound on the flanks of the section bar so that the primary sealing compound, and the compound containing the drying agent are arranged one adjoining the other and the compound containing the drying agent comes to cover the inside of the spacer to the extent it is not covered by the primary sealing compound;
(c) forming the coated section bar into the shape of a frame-like structure;
(d) closing the frame-like structure to form a spacer by joining the ends of the section bar one to the other;
(e) applying the spacer to the first glass pane so that it adheres to the pane in the neighborhood of the edge of the first glass pane;
(f) applying a second glass pane to the spacer in parallel to the first glass pane so that the spacer adheres to the second glass pane as well;
(g) compressing the two glass panes to the thickness predetermined for the insulating glass panel;
(h) bonding, if necessary, the spacer to the two glass panes by application of a secondary sealing compound,
wherein the order in succession of the operations of applying the primary sealing compound and of the compound containing the drying agent may be exchanged or the primary sealing compound and the compound containing the drying agent may be applied simultaneously or in time-overlapping fashion.

95. The method as defined in claim 94, wherein a first rope of the secondary sealing compound is applied between the spacer and the glass pane and a second rope of the secondary sealing compound, separate from the first rope, is applied between the spacer and the second glass pane.

96. Method of producing an insulating glass panel in which two separate glass panes are kept at a distance by a spacer formed from a hollow section bar, which has an inner surface, an outer surface and two flanks,
a drying agent is provided in combination with the spacer,
and a gap is provided on both sides of the spacer between the spacer and the two glass panes which gap is sealed by a primary sealing compound that adheres to the spacer and to the glass panes,
a compound, which contains a drying agent, is arranged beside the primary sealing compound that seals the two gaps, on the side of the spacer (hereinafter also described as the inside) that faces the inner surface of the insulating glass panel, comprising the steps of:
(a) Providing a section bar having a hollow cross-section;
(b1) applying a compound containing a drying agent on the section bar, on the side of the spacer which later forms the inside of the spacer and
applying a primary sealing compound, on the flanks of the section bar so that the primary sealing compound, and the compound containing the drying agent are arranged one adjoining the other and the compound containing the drying agent comes to cover the inside of the spacer to the extent it is not covered by the primary sealing compound;
(b2) applying a secondary sealing compound on the flanks of the section bar;
(c) forming the coated section bar into the shape of a frame-like structure;
(d) closing the frame-like structure to form a spacer by joining the ends of the section bar one to the other;
(e) applying the spacer to the first glass pane so that it adheres to the pane in the neighborhood of the edge of the first glass pane;
(f) applying a second glass pane to the spacer in parallel to the first glass pane so that the spacer adheres to the second glass pane as well;
(g) compressing the two glass panes to the thickness predetermined for the insulating glass panel;
wherein the order in succession of the operations of applying the primary and the secondary sealing compounds and of the compound containing the drying agent may be exchanged or the application operations may be carried out simultaneously or in time-overlapping fashion.

97. Method of producing an insulating glass panel in which two glass panes are firmly bonded one to the other and are sealed by at least one sealing compound, with a frame-like spacer positioned between them, comprising the steps of:
(a) Producing a frame-like spacer from one or more hollow-section bars having a base, two flanks projecting from the base and one side which later faces the inner space of the insulating glass panel;
(b) applying a rope of a compound containing a drying agent upon the side which later faces the inner space of the insulating glass panel;
(c) applying the whole at least one sealing compound on the flanks of the one or more hollow-section bars of the spacer; and
(d) bonding the spacer to the two glass panes,
wherein the order in succession of the steps (a), (b) and (c) may be exchanged.

98. Method of producing an insulating glass panel in which two glass panes are firmly bonded one to the other and are sealed by at least one sealing compound, with a frame-like spacer positioned between them, comprising the steps of:
(a) Providing one or more hollow-section bars having a base, two flanks projecting from the base and one side which later faces the inner space of the insulating glass panel, in linear arrangement;
(b) applying a rope of a compound containing a drying agent upon the side which later faces the inner space of the insulating glass panel;
(c) applying at least one sealing compound on the flanks of the one or more hollow-section bars;
(d) producing a frame-like spacer from the one or more coated hollow-section bars; and
(d) bonding the spacer to the two glass panes,
wherein the order in succession of the steps (b) and (c) may be exchanged.

99. The method as defined in claim 38, wherein a hollow-section bar having a box-shaped hollow cross-section is used.

100. The method as defined in claim 38, wherein a spacer is used which consists of a plastic material at least in part.

101. The method as defined in claim 40, wherein the spacer is formed from one or more section bars extruded from a plastic material.

102. The method as defined in claim 38, wherein the compound, in which the drying agent is embedded, consists of a plastic material with bonding properties.

103. The method as defined in claim 42, wherein the compound in which the drying agent is embedded consists of a thermoplastic material.

104. The method as defined in claim 42, wherein the compound in which the drying agent is embedded consists of a foamed material.

105. The method as defined in claim 38, wherein the compound containing the drying agent consists of a sealing compound which efficiently prevents water vapor from penetrating into the inner space of the insulating glass panel, and which is formulated preferably on the basis of polyisobutylene or other primary sealing compounds usual for insulating glass panels.

106. The method as defined in claim 38, wherein the primary sealing compound applied to the flanks contains a drying agent.

107. The method as defined in claim 46, wherein the primary sealing compound applied to the flanks contains a drying agent in a concentration lower than the compound applied on the side of the spacer which later becomes the inside.

108. The method as defined in claim 38, wherein the primary sealing compound and/or the compound containing the drying agent contains a setting component.

109. The method as defined in claim 38, wherein the secondary sealing compound is applied adjacent the primary sealing compound.

110. The method as defined in claim 38, wherein the secondary sealing compound is applied following the primary sealing compound, but in time-overlapping relationship, or is applied simultaneously with the primary sealing compound.

111. The method as defined in claim 49, wherein the primary sealing compound and the secondary sealing compound are so applied that they project the farthest from the flanks at the places where they are in contact one with the other.

112. The method as defined in claim 50, wherein the primary sealing compound and the secondary sealing compound are so applied that the primary sealing compound will project over the secondary sealing compound at the joint between the two compounds, or is applied at that joint with the same thickness as the secondary sealing compound.

113. The method as defined in claim 38, wherein if desired the section bar is subjected to a cutting operation prior to being coated.

114. The method as defined in claim 38, wherein the section bar is coated using a nozzle, the orifice of which, which may be subdivided if desired, covers the inside of the section bar and at least an adjacent strip of its flanks.

115. The method as defined in claim 54, wherein a nozzle is used which is adjustable in width.

116. The method as defined in claim 54, wherein the compound containing the drying agent and the primary sealing compound are combined in the nozzle.

117. The method as defined in claim 56, wherein the primary and the secondary sealing compounds are likewise combined in the nozzle.

118. The method as defined in claim 38, wherein the ends of the section bar are coated only after they have been connected one with the other.

119. The method as defined in claim 58, wherein a wedge-shaped or groove-shaped recess, extending transversely to the long direction of the section bar, is provided and is subsequently sealed at the joint of the section bar on the side facing the inside.

120. The method as defined in claim 58, wherein the joint is covered with a badge on the side of the section bar facing the inside.

121. The method as defined in claim 60, wherein the badge is provided on its lower face with one or more extensions that are pressed into the compound containing the drying agent.

122. The method as defined in claim 61, wherein the extensions are pushed down into a recess or an opening in the section bar which is covered by the compound containing the drying agent.

123. The method as defined in claim 38 of producing an insulating glass panel in which at least one cross bar is fitted, where an end piece of the cross bar engages a recess or an opening on the inside of the spacer,
wherein the point where the cross bar is to be fitted, is marked on the section bar or on the compound containing the drying agent applied to the inside, and that an end piece is introduced at the marked point through the compound and into the recess or the opening of the spacer located underneath the compound.

124. The method as defined in claim 38, wherein the compound selected as primary sealing compound is one which is particularly well suited for sealing the insulating glass panel from penetrating water vapor, especially one consisting of a thermoplastic polyisobutylene.

125. The method as defined in 38, wherein the compound selected as secondary sealing compound is one which is particularly well suited for bonding the glass panes durably and firmly, especially a curable plastic material, for example a polyurethane or a Thiokol (polysulfide), a reactive polyisobutylene, a silicon resin or a hot-melt.
